(19) United States
(12) Patent Application Publication
(10) Pub. No.: US 2026/0072305 A1
(43) Pub. Date: Mar. 12, 2026

(54) BACKLIGHT UNIT AND DISPLAY APPARATUS INCLUDING THE SAME

(71) Applicant: SAMSUNG ELECTRONICS CO., LTD., Suwon-si (KR)

(72) Inventors: Hyesung HAN, Suwon-si (KR); Sungyeol KIM, Suwon-si (KR); Taeyeon KIM, Suwon-si (KR); Chunsoon PARK, Suwon-si (KR); Hyukjun JANG, Suwon-si (KR)

(73) Assignee: SAMSUNG ELECTRONICS CO., LTD., Suwon-si (KR)

(21) Appl. No.: 19/327,691

(22) Filed: Sep. 12, 2025

Related U.S. Application Data
(63) Continuation of application No. PCT/KR2025/013259, filed on Aug. 29, 2025.

(30) Foreign Application Priority Data
Sep. 12, 2024 (KR) 10-2024-0125126
Nov. 19, 2024 (KR) 10-2024-0165729
Apr. 23, 2025 (KR) 10-2025-0053166

(51) Int. Cl. G02F 1/13357; G02F 1/1335

(52) U.S. Cl. CPC G02F 1/133603; G02F 1/133605; G02F 1/133611; G02F 1/133612; G02F 1/133613; G02F 1/133621

(57) ABSTRACT

There is provided is a display apparatus including a liquid crystal panel and a backlight unit configured to provide light to the liquid crystal panel. The backlight unit includes a substrate, a red light emitting diode mounted on a first surface of the substrate, a green light emitting diode mounted on the first surface of the substrate and a blue light emitting diode mounted on the first surface of the substrate. Each of the red light emitting diode, the green light emitting diode, and the blue light emitting diode includes at least two cells.

### CROSS-REFERENCE TO RELATED APPLICATIONS

This application is a continuation of International Application No. PCT/KR2025/013259, filed on Aug. 29, 2025, which is based on and claims priority to Korean Patent Application No. 10-2024-0125126, filed on Sep. 12, 2024, in the Korean Intellectual Property Office, Korean Patent Application No. 10-2024-0165729, filed on Nov. 19, 2024, in the Korean Intellectual Property Office, and Korean Patent Application No. 10-2025-0053166, filed on Apr. 23, 2025, in the Korean Intellectual Property Office, the disclosures of which are incorporated by reference herein in their entireties.

### BACKGROUND

### 1. Field

The present disclosure relates to a display apparatus including a backlight unit.

### 2. Description of Related Art

Generally, a display apparatus is a type of output device configured to convert acquired or stored electrical information to visual information and display the visual information to a user.

The display apparatus includes a backlight unit configured to provide light to a liquid crystal panel. The backlight unit includes a plurality of point light sources capable of emitting light independently. The light sources include light emitting diodes (LEDs).

The display apparatus enhances contrast ratio and power efficiency through a local dimming system of the backlight unit. The local dimming system divides the screen of the display apparatus into a plurality of regions and controls the amount of current for each region independently based on the input image. The local dimming system improves contrast ratio effectively by reducing the current when the input image is dark and increasing the current when the input image is bright.

Since red, green, and blue light emitting diodes have different driving voltages, voltage loss occurs when they are driven by a common voltage within each block of the local dimming system.

### SUMMARY

One aspect of the present disclosure provides a display apparatus that improves the lifespan and color stability of light emitting diodes by driving the light emitting diodes with high voltage and low current.

One aspect of the present disclosure provides a display apparatus capable of reducing voltage loss while supplying a common voltage to red, green, and blue light emitting diodes.

One aspect of the present disclosure provides a display apparatus in which a red light emitting diode, a green light emitting diode, and a blue light emitting diode form a single light emitting diode group, and the number of cells of the red light emitting diode is greater than the number of cells of the green light emitting diode and the blue light emitting diode.

One aspect of the present disclosure provides a display apparatus including a light emitting diode in which at least one cell is disposed between an anode pad and a cathode pad.

The technical objectives of the present disclosure are not limited to the above, and other objectives that are not described above will be clearly understood by those skilled in the art from the above detailed description.

A display apparatus according to the disclosure includes a liquid crystal panel and a backlight unit configured to provide light to the liquid crystal panel. The backlight unit includes a substrate, a red light emitting diode configured to be mounted on one surface of the substrate, a green light emitting diode configured to be mounted on the one surface of the substrate, and a blue light emitting diode configured to be mounted on the one surface of the substrate. Each of the red light emitting diode, the green light emitting diode, and the blue light emitting diode includes at least two cells.

A display apparatus according to the disclosure includes a liquid crystal panel and a backlight unit configured to provide light to the liquid crystal panel. The backlight unit includes a substrate including an insulating layer and a conductive layer, a light emitting diode configured to be mounted on the substrate and including a first pad corresponding to an anode and a second pad corresponding to a cathode, a first power feeding pad as a part of the conductive layer, provided to connect the anode to the first pad, and a second power feeding pad as a part of the conductive layer, provided to connect the cathode to the second pad. The light emitting diode includes at least one cell disposed between the first pad and the second pad.

There is provided a display apparatus including: a liquid crystal panel; and a backlight unit configured to provide light to the liquid crystal panel, wherein the backlight unit includes: a substrate; a red light emitting diode mounted on a first surface of the substrate; a green light emitting diode mounted on the first surface of the substrate; and a blue light emitting diode mounted on the first surface of the substrate, wherein the red light emitting diode includes a first plurality of cells, wherein the green light emitting diode includes a second plurality of cells, and wherein the blue light emitting diode includes a third plurality of cells.

The first plurality of cells of the red light emitting diode may include four cells, the second plurality of cells of the green light emitting diode may include three cells, and the third plurality of cells of the blue light emitting diode may include three cells.

The first plurality of cells of the red light emitting diode may include five cells, the second plurality of cells of the green light emitting diode may include four cells, and the third plurality of cells of the blue light emitting diode may include four cells.

The display apparatus may include a plurality of red light emitting diodes, the plurality of red light emitting diodes including the red light emitting diode, a plurality of green light emitting diodes, the plurality of green light emitting diodes including the green light emitting diode, and a plurality of blue light emitting diodes, the plurality of blue light emitting diodes including the blue light emitting diode, a plurality of light emitting diode groups arranged in a plurality of rows and a plurality of columns on the substrate, a first light emitting diode group of the plurality of light emitting diode groups including a first red light emitting diode of the plurality of red light emitting diodes, a first green light emitting diode of the plurality of green light emitting diodes, and a first blue light emitting diode of the plurality of blue light emitting diodes, and a second light emitting diode group of the plurality of light emitting diode groups including a second red light emitting diode of the plurality of red light emitting diodes, a second green light emitting diode of the plurality of green light emitting diodes, and a second blue light emitting diode of the plurality of blue light emitting diodes, and a dimming block including ones of the plurality of light emitting diode groups that are configured to be any of turned on and off simultaneously.

The ones of the plurality of light emitting diode groups of the dimming block may include the first light emitting diode group and the second light emitting diode group, a magnitude of a voltage applied to the first red light emitting diode, a magnitude of a voltage applied to the first green light emitting diode, and a magnitude of a voltage applied to the first blue light emitting diode may be provided to be the same, and a magnitude of a voltage applied to the second red light emitting diode, a magnitude of a voltage applied to the second green light emitting diode, and a magnitude of a voltage applied to the second blue light emitting diode may be provided to be the same.

The display apparatus may include a reflective sheet including a plurality of holes, each of which accommodates a respective one of the plurality of light emitting diode groups, configured to cover the first surface of the substrate, and a plurality of optical domes, each provided inside a respective one of the plurality of holes, configured to cover a corresponding one of the plurality of light emitting diode groups.

The display apparatus may include a first power feeding pad, that is a part of a conductive layer that is at least a portion of the first surface of the substrate, configured to apply a positive voltage to the red light emitting diode, the green light emitting diode, and the blue light emitting diode; and a second power feeding pad, that is a part of the conductive layer, configured to apply a negative voltage to the red light emitting diode, the green light emitting diode, and the blue light emitting diode.

The red light emitting diode may include a first pad, configured to be electrically connected to the first power feeding pad, and a second pad configured to be electrically connected to the second power feeding pad; the green light emitting diode may include a third pad, configured to be electrically connected to the first power feeding pad, and a fourth pad configured to be electrically connected to the second power feeding pad; and the blue light emitting diode may include a fifth pad, configured to be electrically connected to the first power feeding pad, and a sixth pad configured to be electrically connected to the second power feeding pad.

The first plurality of cells of the red light emitting diode may include two cells disposed between the first pad and the second pad; the second plurality of cells of the green light emitting diode may include one cell disposed between the third pad and the fourth pad; and the third plurality of cells of the blue light emitting diode may include one cell disposed between the fifth pad and the sixth pad.

The first plurality of cells of the red light emitting diode may include three cells disposed between the first pad and the second pad; the second plurality of cells of the green light emitting diode may include two cells disposed between the third pad and the fourth pad; and the third plurality of cells of the blue light emitting diode may include two cells disposed between the fifth pad and the sixth pad.

A length of a short side of each of the two cells disposed between the first pad and the second pad of the red light emitting diode may be 100 μm or less; a length of a short side of the one cell disposed between the third pad and the fourth pad of the green light emitting diode may be 100 μm or less; and a length of a short side of the one cell disposed between the fifth pad and the sixth pad of the blue light emitting diode may be 100 μm or less.

There is provided a display apparatus including: a liquid crystal panel; and a backlight unit configured to provide light to the liquid crystal panel, and the backlight unit includes a substrate including an insulating layer and a conductive layer; a light emitting diode mounted on the substrate and including a first pad, that is an anode, and a second pad that is a cathode; a first power feeding pad of the conductive layer and configured to connect a positive electrode to the first pad; and a second power feeding pad of the conductive layer configured to connect a negative electrode to the second pad, wherein the light emitting diode includes at least one cell disposed between the first pad and the second pad.

The light emitting diode may be one of a red light emitting diode, a green light emitting diode, and a blue light emitting diode, the red light emitting diode includes two cells disposed between the first pad and the second pad, the green light emitting diode includes one cell disposed between the first pad and the second pad, and the blue light emitting diode includes one cell disposed between the first pad and the second pad.

The red light emitting diode may include four cells, the green light emitting diode may include three cells, and the blue light emitting diode may include three cells.

The light emitting diode may be one of a red light emitting diode, a green light emitting diode, and a blue light emitting diode, the red light emitting diode may include three cells disposed between the first pad and the second pad; the green light emitting diode may include two cells disposed between the first pad and the second pad; and the blue light emitting diode may include two cells disposed between the first pad and the second pad.

### BRIEF DESCRIPTION OF THE DRAWINGS

The above and other aspects, features, and advantages of specific embodiments of the present disclosure will be more apparent from the following description with reference to the accompanying drawings, in which:

FIG. 1 illustrates a display apparatus according to one or more embodiments;

FIG. 2 is an exploded view of a display apparatus according to one or more embodiments;

FIG. 3 is a cross-sectional view of a liquid crystal panel of a display apparatus according to one or more embodiments;

FIG. 4 is an exploded view of a backlight unit according to one or more embodiments;

FIG. 5 is a plan view of a light source module for explaining the concept of a dimming block in a backlight unit according to one or more embodiments;

FIG. 6 is a perspective view showing an enlarged portion A of FIG. 5;

FIG. 7 is an exploded view of the light source shown in FIG. 6;

FIG. 8 schematically illustrates dimming blocks according to one or more embodiments;

FIG. 9 conceptually illustrates internal structures of light emitting diodes in a light emitting diode group according to one or more embodiments;

FIG. 10 is a diagram for explaining connection wirings between a power assembly and light emitting diodes according to one or more embodiments;

FIG. 11 is a diagram for explaining connection wirings between a power assembly and light emitting diodes according to one or more embodiments;

FIG. 12 conceptually illustrates internal structures of light emitting diodes in a light emitting diode group according to one or more embodiments;

FIG. 13 conceptually illustrates internal structures of light emitting diodes in a light emitting diode group according to one or more embodiments;

FIG. 14 conceptually illustrates internal structures of light emitting diodes in a light emitting diode group according to one or more embodiments;

FIG. 15 illustrates a light emitting diode including two cells in a display apparatus according to one or more embodiments;

FIG. 16 illustrates a light emitting diode including three cells in a display apparatus according to one or more embodiments;

FIG. 17 illustrates a light emitting diode including four cells in a display apparatus according to one or more embodiments;

FIG. 18 illustrates a light emitting diode including five cells in a display apparatus according to one or more embodiments;

FIG. 19 illustrates a light emitting diode including eight cells in a display apparatus according to one or more embodiments;

FIG. 20 illustrates a light emitting diode including eight cells in a display apparatus according to one or more embodiments; and

FIG. 21 illustrates a light emitting diode including six cells in a display apparatus according to one or more embodiments.

### DETAILED DESCRIPTION

The embodiments described in the disclosure and the configurations shown in the drawings are only examples of the disclosure, and various modifications may be made at the time of filing of the disclosure to replace the embodiments and drawings of the disclosure.

In the description of the drawings, like numbers refer to like elements throughout the description of the drawings.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

The terms of “˜part”, “˜module” and “˜member” may be implemented in hardware or software. In some embodiments, a plurality of “˜parts”, “˜modules” and “˜members” may be implemented as a single component. In some embodiments, a single “˜part”, “˜module” and “˜member” may include a plurality of components.

The terms used herein are for the purpose of describing the embodiments and are not intended to restrict and/or to limit the disclosure. The singular expressions herein may include plural expressions, unless the context clearly dictates otherwise. In addition, the terms “comprises”, “includes”, and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. used in the disclosure may be used herein to describe various components, these components should not be limited by these terms. These terms are only used to distinguish one component from another. For example, a first element could be termed a second element, and similarly, a second element could be termed a first element without departing from the scope of the disclosure. The term “and/or” includes combinations of one or all of a plurality of associated listed items.

When one (e.g., a first) element is referred to as being “coupled” or “connected” to another (e.g., a second) element with or without the term “functionally” or “communicatively,” it means that the one element is connected to the other element directly, wirelessly, or via a third element.

It will be understood that when a certain component is referred to as being “connected to”, “coupled to”, “supported by” or “in contact with” another component, it may be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” another component, it may be directly on the other component or intervening components may also be present.

Meanwhile, the terms such as “vertical direction,” “front-rear direction,” and the like used in the following description are defined based on the accompanying drawings, and the shapes and positions of the respective components are not limited by these terms. For example, the term “front” may refer to the +X direction shown in the drawings, and the term “rear” may refer to the −X direction. The term “upward” may refer to the +Z direction, and the term “downward” may refer to the −Z direction as shown in the drawings. The terms “leftward” and “rightward” may refer to the +Y and −Y directions, respectively. The term “vertical direction” may refer to the Z direction in the drawings, and the term “horizontal direction” may refer to the Y direction. However, in some drawings, the +X direction may be referred to as “upward,” and the −X direction may be referred to as “downward.”

Hereinafter, embodiments according to the present disclosure will be described in detail with reference to the accompanying drawings

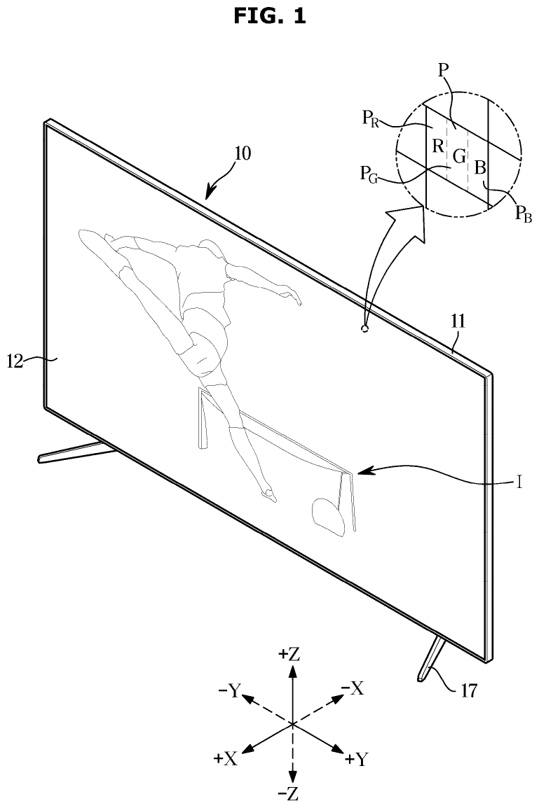

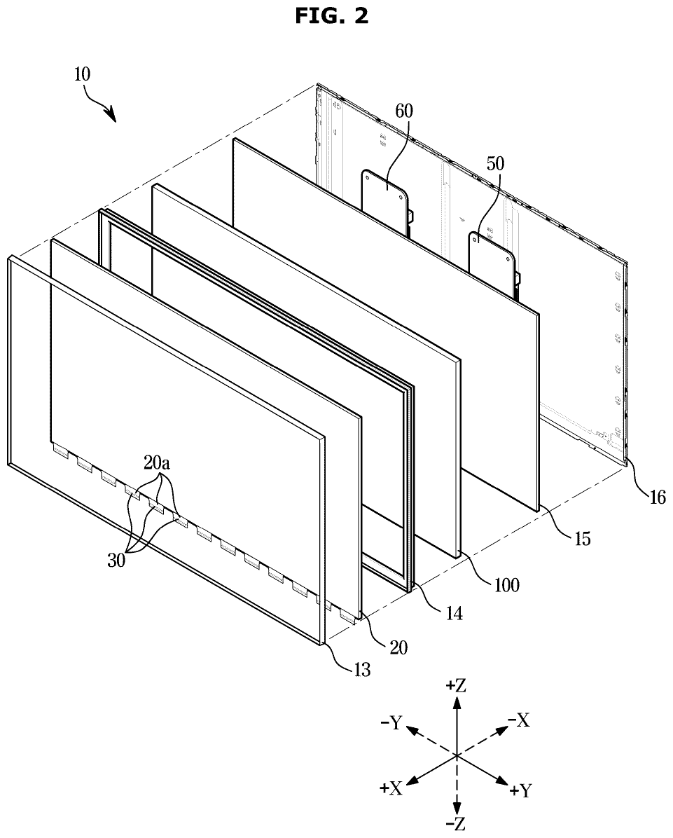

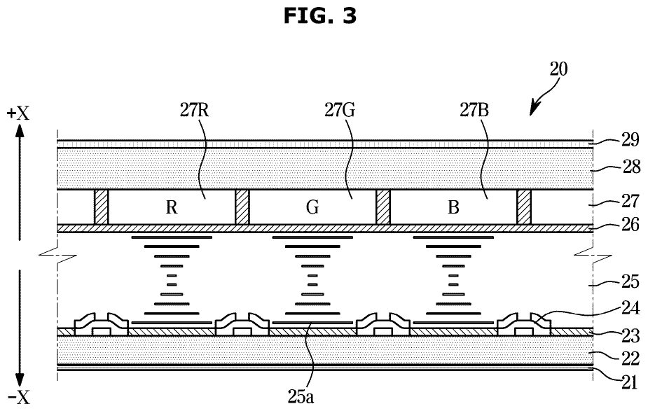

FIG. 1 is a view illustrating a display apparatus according to one or more embodiments. FIG. 2 is an exploded view of a display apparatus according to one or more embodiments. FIG. 3 is a view illustrating a cross-section of a liquid crystal panel of a display apparatus according to one or more embodiments.

Referring to FIG. 1, the display apparatus 10 is a device capable of processing an image signal received from the outside and visually displaying the processed image. Hereinafter, an example in which the display apparatus 10 is a television (TV) is described, but the present disclosure is not limited thereto. For example, the display apparatus 10 may be implemented in various forms such as a monitor, a portable multimedia device, a portable communication device, and the like, and the forms of the display apparatus 10 are not limited in the case of a device configured to visually display an image.

In addition, the display apparatus 10 may be a large format display (LFD) installed at the outside such as on a rooftop of a building or at a bus stop. Here, the outside is not necessarily limited to the outdoors, and the display apparatus 10 according to one or more embodiments may be installed in a place in which a large number of people may enter and exit even in the case of indoors such as a subway station, a shopping mall, a movie theater, a company, a store, or the like.

The display apparatus 10 may receive content data including video data and audio data from various content sources, and output a video and an audio respectively corresponding to the video data and the audio data. For example, the display apparatus 10 may receive content data through a broadcast reception antenna or a wired cable, receive content data from a content reproduction device, or receive content data from a content providing server of a content provider.

As shown in FIG. 1, the display apparatus 10 includes a main body 11, a screen 12 configured to display an image I, and a support 17 provided under the main body 11 to support the main body 11.

The main body 11 forms an appearance of the display apparatus 10, and components configured to cause the display apparatus 10 to display the image I or perform various functions may be provided in the main body 11. The main body 11 shown in FIG. 1 has a flat plate shape, but the shape of the main body 11 is not limited to the case shown in FIG. 1. For example, the main body 11 may have a curved plate shape.

The screen 12 may be formed on a front surface of the main body 11, and may display the image I. For example, the screen 12 may display a still image or a video. Further, the screen 12 may display a two-dimensional flat image or a three-dimensional stereoscopic image using the parallax of a user's eyes.

A plurality of pixels P are formed on the screen 12, and the image I displayed on the screen 12 may be formed by light emitted from each of the plurality of pixels P. For example, the image I may be formed on the screen 12 by combining the light emitted by the plurality of pixels P like a mosaic.

Each of the plurality of pixels P may emit light of various brightness and colors. For example, each of the plurality of pixels P includes a self-luminous light-emitting panel (for example, a light-emitting diode panel) capable of directly emitting light, or a non-self-luminous light-emitting panel capable of allowing light emitted by a backlight unit or the like to pass therethrough or blocking the light (for example, a liquid crystal panel).

In order to emit light of various colors, each of the plurality of pixels P may include sub-pixels, such as a red sub-pixel PR, a green sub-pixel PG, and a blue sub-pixel PB.

The sub-pixels may include the red sub-pixel PR capable of emitting red light, the green sub-pixel PG capable of emitting green light, and the blue sub-pixel PB capable of emitting blue light. For example, the red light may represent light of a wavelength from approximately 620 nm (nanometer, billionths of a meter) to 750 nm, the green light may represent light of a wavelength from approximately 495 nm to 570 nm, and the blue light may represent light of a wavelength from approximately 450 nm to 495 nm.

The light of various brightness and colors may be emitted from each of the plurality of pixels P by combination of the red light of the red sub-pixel PR, the green light of the green sub-pixel PG, and the blue light of the blue sub-pixel PB.

As shown in FIG. 2, various components configured to generate the image I on a screen 12 may be provided in the main body 11.

For example, the main body 11 may be provided at an inside thereof with a backlight unit 100 which is a surface light source, a liquid crystal panel 20 configured to block the light emitted from the backlight unit 100 or allow the light to pass therethrough, a control assembly 50 configured to control operations of the backlight unit 100 and the liquid crystal panel 20, and a power assembly 60 configured to supply power to the backlight unit 100 and the liquid crystal panel 20. Further, the main body 11 includes a bezel 13, a frame middle mold 14, a bottom chassis 15, and a back cover 16 configured to support and fix the liquid crystal panel 20, the backlight unit 100, the control assembly 50, and the power assembly 60.

The backlight unit 100 may include a point light source configured to emit monochromatic light or white light, and may diffuse, refract, reflect, and scatter the light to convert light emitted from the point light source to uniform surface light. For example, the backlight unit 100 may include a plurality of light sources configured to emit the monochromatic light or the white light, a diffuser plate configured to diffuse light incident from the plurality of light sources, a reflective sheet configured to reflect light emitted from the plurality of light sources 111 and a back surface of the diffuser plate, and an optical sheet configured to refract and scatter light emitted from a front surface of the diffuser plate.

Like the above, the backlight unit 100 may emit the uniform surface light toward the front by diffusing, refracting, reflecting, and scattering the light emitted from the light sources.

Configurations of the backlight unit 100 will be described below in more detail.

The liquid crystal panel 20 may be provided in front of the backlight unit 100. The liquid crystal panel 20 may block the light emitted from the backlight unit 100 or allow the light to pass therethrough to form the image I.

A front surface of the liquid crystal panel 20 may form the screen 12 of the above-described display apparatus 10, and the liquid crystal panel 20 may include the plurality of pixels P. In the liquid crystal panel 20, the plurality of pixels P may each be controlled to independently block the light of the backlight unit 100 or allow the light to pass therethrough, and the light passing through the plurality of pixels P may form the image I displayed on the screen 12.

For example, as shown in FIG. 3, the liquid crystal panel 20 may include a first polarization film 21, a first transparent substrate 22, a pixel electrode 23, a thin film transistor 24, a liquid crystal layer 25, a common electrode 26, a color filter 27, a second transparent substrate 28, and a second polarization film 29.

The first transparent substrate 22 and the second transparent substrate 28 may fix and support the pixel electrode 23, the thin film transistor 24, the liquid crystal layer 25, the common electrode 26, and the color filter 27. The first transparent substrate 22 and the second transparent substrate 28 may be composed of tempered glass or a transparent resin.

The first polarization film 21 and the second polarization film 29 are respectively provided at outer sides of the first transparent substrate 22 and the second transparent substrate 28.

Each of the first polarization film 21 and the second polarization film 29 may allow specific light to pass therethrough and block other light. For example, the first polarization film 21 allows light having a magnetic field which oscillates in a first direction to pass therethrough and blocks other light. Further, the second polarization film 29 allows light having a magnetic field which oscillates in a second direction to pass therethrough and blocks other light. In this case, the first direction and the second direction may be orthogonal to each other. Accordingly, a polarization direction of the light passing through the first polarization film 21 and an oscillation direction of the light passing through the second polarization film 29 are orthogonal to each other. As a result, generally, light may not pass through the first polarization film 21 and the second polarization film 29 at the same time.

The color filter 27 may be provided at an inner side of the second transparent substrate 28.

The color filter 27 may include, for example, a red filter 27R configured to allow red light to pass therethrough, a green filter 27G configured to allow green light to pass therethrough, and a blue filter 27B configured to allow blue light to pass therethrough, and the red filter 27R, the green filter 27G, and the blue filter 27B may be disposed in parallel. A region in which the color filter 27 is formed corresponds to the above-described pixel P. A region in which the red filter 27R is formed corresponds to the red sub-pixel PR, a region in which the green filter 27G is formed corresponds to the green sub-pixel PG, and a region in which the blue filter 27B is formed corresponds to the blue sub-pixel PB.

The pixel electrode 23 may be provided at an inner side of the first transparent substrate 22, and the common electrode 26 may be provided at the inner side of the second transparent substrate 28.

The pixel electrode 23 and the common electrode 26 may be composed of a metal material that conducts electricity, and may generate an electric field for changing the arrangement of liquid crystal molecules constituting the liquid crystal layer 25 to be described below.

The pixel electrode 23 and the common electrode 26 may be composed of a transparent material, and may allow light incident from the outside to pass therethrough. For example, the pixel electrode 23 and the common electrode 26 may be composed of indium tin oxide (ITO), indium zinc oxide (IZO), a silver nanowire (Ag nanowire), a carbon nanotube (CNT), graphene, poly3,4-ethylenedioxythiophene) (PEDOT), or the like.

The thin film transistor (TFT) 24 is provided at the inner side of the first transparent substrate 22.

The thin film transistor 24 may allow a current flowing through the pixel electrode 23 to pass therethrough or block the current. For example, an electric field may be formed or removed between the pixel electrode 23 and the common electrode 26 according to turn-on (closed) or turn-off (open) of the thin film transistor 24.

The thin film transistor 24 may be composed of poly-silicon, and may be formed by semiconductor processes such as a lithography process, a deposition process, an ion implantation process, and the like.

The liquid crystal layer 25 is formed between the pixel electrode 23 and the common electrode 26, and is filled with the liquid crystal molecules.

A liquid crystal indicates an intermediate state between a solid (crystal) and a liquid. Most of the liquid crystal materials are organic compounds, their molecular shape is a long and thin rod, and may have a crystal form in which the arrangement of the molecules is irregular in any direction, but is regular in another direction. As a result, the liquid crystal has both fluidity of the liquid and optical anisotropy of the crystal (solid).

Further, the liquid crystal also exhibits optical properties according to a change in electric field. For example, in the liquid crystal, the direction of the arrangement of molecules constituting the liquid crystal may be changed according to the change in electric field. When the electric field is generated in the liquid crystal layer 25, the liquid crystal molecules of the liquid crystal layer 25 are arranged according to the direction of the electric field, and when the electric field is not generated in the liquid crystal layer 25, the liquid crystal molecules may be irregularly arranged or may be arranged along an alignment layer. As a result, the optical properties of the liquid crystal layer 25 may be changed according to the presence or absence of the electric field passing through the liquid crystal layer 25.

A cable 20a configured to transmit image data to the liquid crystal panel 20, and a display driver integrated circuit 30 (DDI, hereinafter, referred to as a ‘driver IC’) configured to process digital image data and output an analog image signal are provided at one side of the liquid crystal panel 20.

The cable 20a may electrically connect the control assembly 50/power assembly 60 and the driver IC 30, and may also electrically connect the driver IC 30 and the liquid crystal panel 20. The cable 20a may include a flexible flat cable, a film cable, or the like, which may be bent.

The driver IC 30 receives the image data and power from the control assembly 50/power assembly 60 through the cable 20a, and supplies the image data and a driving current to the liquid crystal panel 20 through the cable 20a.

Further, the cable 20a and the driver IC 30 may be integrally implemented as a film cable, a chip on film (COF), a tape carrier package (TCP), or the like. In other words, the driver IC 30 may be disposed on the cable. However, the present disclosure is not limited thereto, and the driver IC 30 may be disposed on the liquid crystal panel 20.

The control assembly 50 may include a control circuit configured to control the operations of the liquid crystal panel 20 and the backlight unit 100. The control circuit may process image data received from an external content source, transmit the image data to the liquid crystal panel 20, and transmit dimming data to the backlight unit 100.

The power assembly 60 may supply power to the liquid crystal panel 20 and the backlight unit 100 so that the backlight unit 100 outputs surface light and the liquid crystal panel 20 blocks the light from the backlight unit 100 or allows the light to pass therethrough.

The control assembly 50 and the power assembly 60 may be implemented as a printed circuit board and various circuits mounted on the printed circuit board. For example, the power circuit may include a capacitor, a coil, a resistor, a processor, and the like, and a power circuit board on which the above parts are mounted. Further, the control circuit may include a memory, a processor, and a control circuit board on which the above parts are mounted.

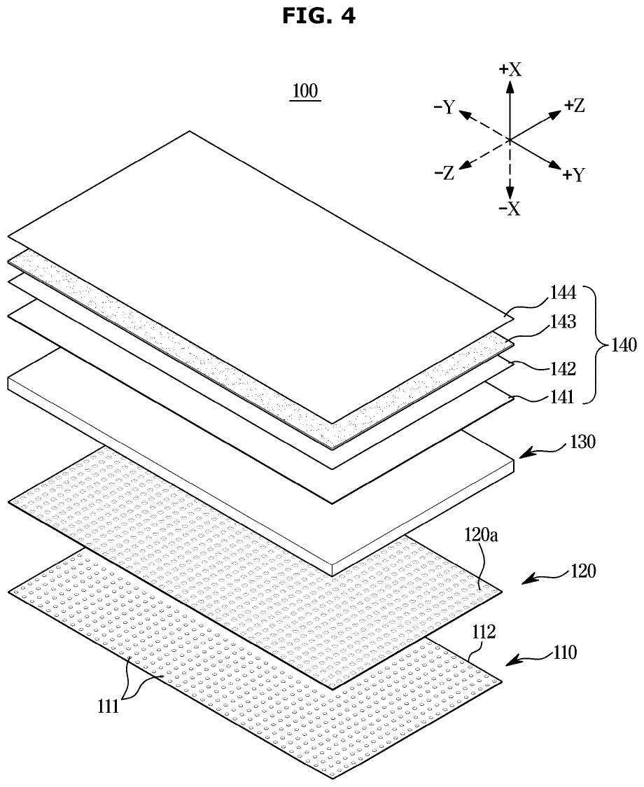

FIG. 4 is an exploded view of a backlight unit according to one or more embodiments.

The backlight unit 100 may include a light source module 110 configured to generate light, a reflective sheet 120 configured to reflect the light, a diffuser plate 130 configured to uniformly diffuse the light, and an optical sheet 140 configured to enhance the luminance of the emitted light.

The light source module 110 may include a plurality of light sources 111 configured to emit light and a substrate 112 configured to support or fix the plurality of light sources 111.

The plurality of light sources 111 may be disposed in a predetermined pattern so that light may be emitted with uniform luminance. The plurality of light sources 111 may be disposed so that distances between one light source and light sources adjacent thereto may become the same.

For example, the plurality of light sources 111 may be disposed in rows and columns. Accordingly, a plurality of light sources may be disposed so that that a substantially square may be formed by four adjacent light sources. Further, any one light source may be disposed adjacent to the four light sources, and distances between the one light source and the four light sources adjacent thereto may be approximately the same.

As another example, the plurality of light sources may be disposed in a plurality of rows, and a light source belonging to each row may be disposed at a center between two light sources belonging to adjacent rows. Accordingly, the plurality of light sources may be disposed so that an approximately equilateral triangle may be formed by three adjacent light sources. In this case, one light source may be disposed adjacent to six light sources, and distances between the one light source and the six light sources adjacent thereto may be approximately the same.

However, the pattern in which the plurality of light sources 111 are disposed is not limited to the above-described pattern, and the plurality of light sources 111 may be disposed in various patterns so that light may be emitted with uniform luminance.

The light source 111 may employ an element capable of emitting monochromatic light (light of a specific wavelength, for example, blue light) or white light (for example, a mixture of red light, green light, and blue light) in various directions when power is supplied. For example, the light source 111 may include a light-emitting diode (LED).

The substrate 112 may fix the plurality of light sources 111 so that positions of the light sources 111 are not changed. Further, the substrate 112 may supply power for emitting light by the light sources 111 to each light source 111.

The substrate 112 may be composed of a synthetic resin or tempered glass or a printed circuit board (PCB) formed with a conductive power feeding line configured to fix the plurality of light sources 111 and supply the power to the light sources 111.

The reflective sheet 120 may reflect the light emitted from the plurality of light sources 111 in a frontward direction or in a direction close to the frontward direction.

A plurality of through holes 120a may be formed in the reflective sheet 120 at positions respectively corresponding to the plurality of light sources 111 of the light source module 110. Further, the light sources 111 of the light source module 110 may pass through the through holes 120a and protrude in front of the reflective sheet 120.

For example, during the assembly process of the reflective sheet 120 and the light source module 110, the plurality of light sources 111 of the light source module 110 may be inserted into the plurality of through-holes 120a formed in the reflective sheet 120. Accordingly, although the substrate 112 of the light source module 110 is located at the rear of the reflective sheet 120, the plurality of light sources 111 of the light source module 110 may be located in front of the reflective sheet 120.

With this structure, the plurality of light sources 111 may emit light from the front of the reflective sheet 120.

The plurality of light sources 111 may emit light in various directions in front of the reflective sheet 120. The light may be emitted toward the diffuser plate 130 from the light sources 111 as well as toward the reflective sheet 120 from the light sources 111, and the reflective sheet 120 may reflect the light emitted toward the reflective sheet 120 toward the diffuser plate 130.

The light emitted from the light sources 111 passes through various objects such as the diffuser plate 130, the optical sheet 140, and the like. When the light passes through the diffuser plate 130 and the optical sheet 140, some of the incident light is reflected from the surfaces of the diffuser plate 130 and the optical sheet 140. The reflective sheet 120 may reflect the light reflected by the diffuser plate 130 and the optical sheet 140.

The diffuser plate 130 may be provided in front of the light source module 110 and the reflective sheet 120, and may uniformly distribute the light emitted from the light sources 111 of the light source module 110.

The diffuser plate 130 may diffuse the light emitted from the plurality of light sources 111 in the diffuser plate 130 to remove the luminance non-uniformity caused by the plurality of light sources 111 arranged to be spaced apart from each other. In other words, the diffuser plate 130 may uniformly emit the non-uniform light from the plurality of light sources 111 to the front.

The optical sheet 140 may include various sheets for improving luminance and luminance uniformity. For example, the optical sheet 140 may include a diffuser sheet 141, a first prism sheet 142, a second prism sheet 143, a reflective polarization sheet 144, and the like. However, the present disclosure is not limited thereto. The optical sheet 140 may include at least one of a diffuser sheet 141, a first prism sheet 142, a second prism sheet 143, and a reflective polarization sheet 144.

The diffuser sheet 141 may diffuse light for luminance uniformity. The light emitted from the light source 111 may be diffused by the diffuser plate 130 and may be diffused again by the diffuser sheet 141 included in the optical sheet 140.

The first prism sheet 142 and the second prism sheet 143 may increase luminance by focusing the light diffused by the diffuser sheet 141. The first prism sheet 142 and the second prism sheet 143 may include a prism pattern having a triangular prism shape, and a plurality of the prism patterns are arranged to be adjacent to each other to form a plurality of bands.

The reflective polarization sheet 144 is a type of polarization film, and may transmit some of the incident light to improve luminance and reflect the remaining light. For example, polarized light in the same direction as a predetermined polarization direction of the reflective polarization sheet 144 may be transmitted, and polarized light in a direction different from the polarization direction of the reflective polarization sheet 144 may be reflected. Further, the light reflected by the reflective polarization sheet 144 may be recycled in the backlight unit 100, and the luminance of the display apparatus 10 may be improved by such light recycling.

The optical sheet 140 is not limited to the sheet or film shown in FIG. 4, and may include more various sheets or films, such as a protection sheet and the like.

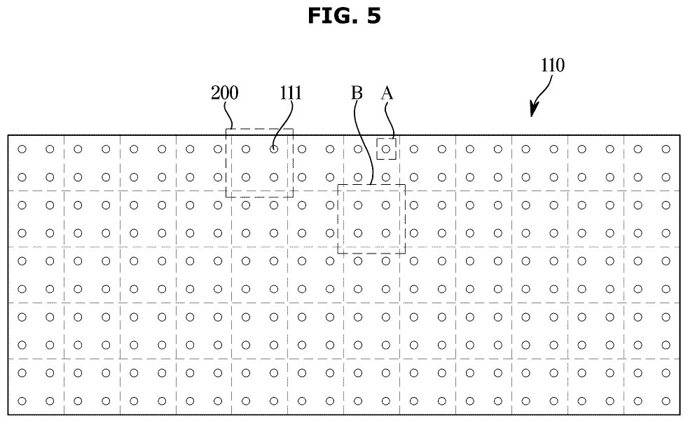

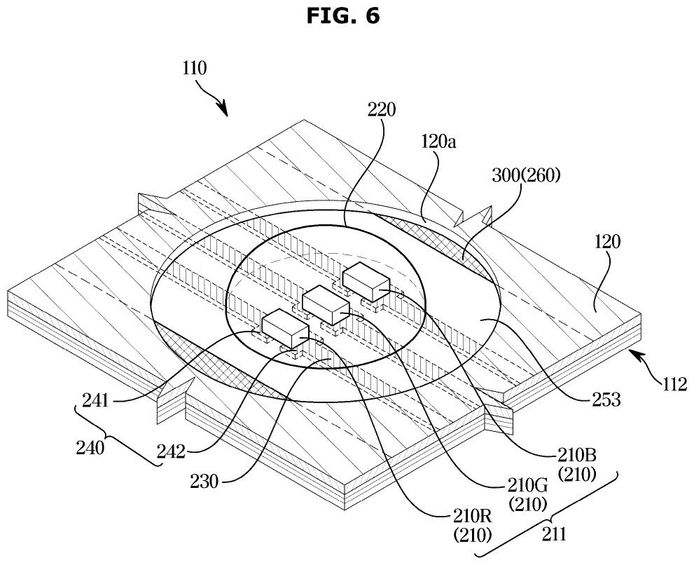

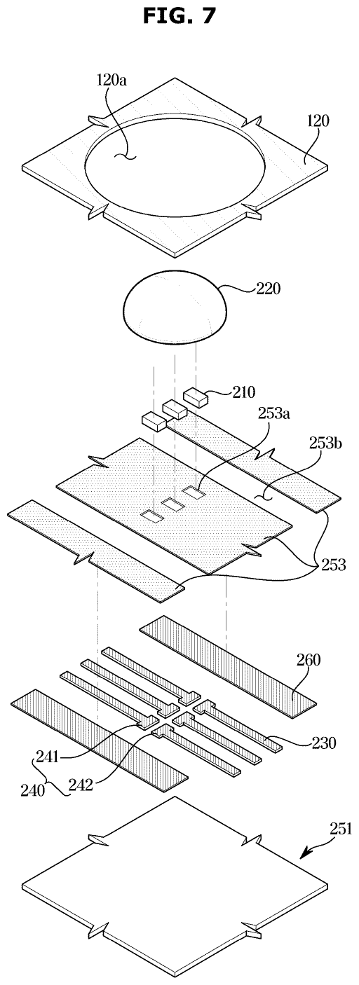

FIG. 5 is a plan view of a light source module for explaining the concept of a dimming block in the backlight unit according to one or more embodiments. FIG. 6 is a perspective view showing an enlarged view of part A of FIG. 5. FIG. 7 is an exploded view of the light source shown in FIG. 6.

A display apparatus 10 according to the present disclosure may perform local dimming that varies the brightness of light in respective regions of a backlight unit 100 in association with an output image so as to improve contrast ratio while reducing power consumption.

For example, the display apparatus 10 may reduce the brightness of light emitted from light sources 111 of the backlight unit 100 corresponding to a dark portion of an image in order to make the dark portion darker. The display apparatus 10 may increase the brightness of light emitted from the light sources 111 of the backlight unit 100 corresponding to a bright portion of the image in order to make the bright portion brighter. Accordingly, the contrast ratio of the image may be improved.

The display apparatus 10 may divide the light sources 111 of the backlight unit 100 into a plurality of blocks and control the current supplied to each of the blocks independently in order to perform the above-described local dimming. Hereinafter, each of the above-described plurality of blocks may be referred to as a dimming block 200. The display apparatus 10 may independently adjust the current supplied to each dimming block 200 according to an input image.

The display apparatus 10 may improve the contrast ratio effectively by decreasing the current supplied to a dimming block 200 corresponding to a dark area of the input image and increasing the current supplied to a dimming block 200 corresponding to a bright area of the input image.

As described above, the plurality of light sources 111 included in the backlight unit 100 may be divided into a plurality of dimming blocks 200. The plurality of dimming blocks 200 may be arranged in a matrix form on a substrate 112. For example, as shown in FIG. 5, the plurality of dimming blocks 200 may include a total of 60 blocks arranged in five rows and twelve columns. However, the number of dimming blocks 200 and the numbers of rows and columns are not limited thereto.

The backlight unit 100 may include the plurality of dimming blocks 200, and each of the plurality of dimming blocks 200 may include at least one light source 111. The backlight unit 100 may supply the same driving current to the light sources 111 belonging to the same dimming block 200. The light sources 111 belonging to the same dimming block 200 and supplied with the same driving current may emit light having the same brightness. However, as will be described later, in a case where a single light source 111 includes a red light emitting diode 210R, a green light emitting diode 210G, and a blue light emitting diode 210B, red light emitting diodes 210R connected in series within the same dimming block 200 may emit light having the same brightness, green light emitting diodes 210G connected in series may emit light having the same brightness, and blue light emitting diodes 210B connected in series may emit light having the same brightness.

The backlight unit 100 may supply different driving currents to light sources 111 belonging to different dimming blocks 200 according to dimming data. The light sources 111 belonging to different dimming blocks 200 may emit light having different brightness levels. In other words, when a first dimming block and a second dimming block are supplied with different driving currents, the light sources belonging to the first dimming block and the light sources belonging to the second dimming block may emit light having different brightness levels. However, as will be described later, in a case where one light source 111 includes a red light emitting diode 210R, a green light emitting diode 210G, and a blue light emitting diode 210B, the red light emitting diodes 210R belonging to the first dimming block and the red light emitting diodes 210R belonging to the second dimming block may emit light having different brightness levels; the green light emitting diodes 210G belonging to the first dimming block and the green light emitting diodes 210G belonging to the second dimming block may emit light having different brightness levels; and the blue light emitting diodes 210B belonging to the first dimming block and the blue light emitting diodes 210B belonging to the second dimming block may emit light having different brightness levels.

Referring to FIG. 5, each of the plurality of dimming blocks 200 may include MxN light sources 111 arranged in an M×N matrix form (where M and N are natural numbers). The M×N matrix means a matrix having M rows and N columns. According to one or more embodiments, each of the plurality of dimming blocks 200 may include four light sources 111 arranged in a 2×2 matrix form. The four light sources 111 forming one dimming block 200 may be configured to be turned on or off simultaneously.

Referring to FIG. 4, FIG. 5, and FIG. 6, the light source module 110 may include a plurality of light sources 111. Each of the plurality of light sources 111 may protrude to the front of the reflective sheet 120 by passing through a through hole 120a from the rear of the reflective sheet 120. Accordingly, as shown in FIG. 6, the light source 111 and a portion of the substrate 112 may be exposed toward the front of the reflective sheet 120 through the through hole 120a.

Each light source 111 may include an electrical/mechanical structure disposed in a region defined by the through hole 120a of the reflective sheet 120.

Each of the plurality of light sources 111 may include at least one light emitting diode 210 and an optical dome 220 configured to cover the at least one light emitting diode 210.

According to one or more embodiments, each light source 111 may include three light emitting diodes 210 and one optical dome 220 configured to cover the three light emitting diodes. In other words, the optical dome 220 may accommodate three light emitting diodes 210 therein. However, the present disclosure is not limited thereto. Each light source may include two light emitting diodes and one optical dome configured to cover the two light emitting diodes. Each light source may include one light emitting diode and one optical dome configured to cover the one light emitting diode.

Each light source 111 may include one light emitting diode group 211. The light emitting diode group 211 may refer to three light emitting diodes, such as a red light emitting diode 210R, a green light emitting diode 210G, and a blue light emitting diode 210B, that are covered by one optical dome 220. One light emitting diode group 211 may include a red light emitting diode 210R configured to emit red light, a green light emitting diode 210G configured to emit green light, and a blue light emitting diode 210B configured to emit blue light. Each light source 111 may include one light emitting diode group 211 and one optical dome 220 configured to cover the same.

As described above, each of the plurality of dimming blocks 200 may include four light sources 111 arranged in a 2×2 matrix form. Each dimming block 200 may include four light emitting diode groups 211 configured to be turned on or off simultaneously. The light emitting diodes of the four light emitting diode groups 211 may be connected in series with each other. Specifically, the red light emitting diodes 210R of the four light emitting diode groups 211 may be connected in series with each other. The green light emitting diodes 210G of the four light emitting diode groups 211 may be connected in series with each other. The blue light emitting diodes 210B of the four light emitting diode groups 211 may be connected in series with each other.

The light emitting diode 210 may include a P-type semiconductor and an N-type semiconductor for emitting light through recombination of holes and electrons. In addition, the light emitting diode 210 may be provided with a pair of electrodes configured to supply holes and electrons to the P-type and N-type semiconductors, respectively.

The light emitting diode 210 may convert electrical energy into optical energy. In other words, the light emitting diode 210 may emit light having a peak intensity at a predetermined wavelength when power is supplied. For example, the blue light emitting diode 210B may emit blue light having a peak wavelength in a blue range (e.g., between 450 nm and 495 nm).

The light emitting diode 210 may be directly mounted on the substrate 112 in a chip-on-board (COB) manner. In other words, the light source 111 may include the light emitting diode 210 in which a light emitting diode chip or a light emitting diode die is directly attached to the substrate 112 without a separate package.

In order to improve the uniformity of surface light emitted by the backlight unit 100 and to enhance the contrast ratio by local dimming, the number of light sources 111 may be increased. As a result, the area that may be occupied by each of the plurality of light sources 111 may be reduced.

To reduce the area occupied by each of the plurality of light sources 111, the light source 111 may omit an antistatic circuit (e.g., a Zener diode) for preventing or suppressing damage to the light emitting diode 210 caused by electrostatic discharge. In other words, the light source 111 may not include a Zener diode connected in parallel to the light emitting diode 210.

In order to reduce the area occupied by the light emitting diode 210, the light emitting diode 210 may be implemented in a flip chip type that does not include a Zener diode. A flip chip type light emitting diode 210 may directly bond the electrode pattern of the semiconductor element to the substrate 112 without using an intermediate medium such as a metal lead (wire) or a ball grid array (BGA) when attaching the light emitting diode as a semiconductor device to the substrate 112.

As such, by omitting the metal lead or ball grid array, a light source 111 including the flip chip type light emitting diode 210 may be miniaturized.

To achieve the miniaturization of the light source 111, a light source module 110 may be manufactured in which the flip chip type light emitting diode 210 is mounted on the substrate 112 in a chip-on-board manner.

The substrate 112 may be provided with a power feeding line 230 and a power feeding pad 240 for supplying power to the flip chip type light emitting diode 210.

The substrate 112 may be provided with a power feeding line 230 configured to supply an electric signal and/or power from a control assembly 50 and/or a power supply assembly 60 to the light emitting diode 210.

The substrate 112 may be formed by alternately stacking a non-conductive insulating layer 251 and a conductive layer.

The conductive layer may include a line or pattern through which power and/or an electric signal flows. The conductive layer may be formed of various materials having electrical conductivity. For example, the conductive layer may be made of various metal materials such as copper (Cu), tin (Sn), aluminum (Al), or an alloy thereof.

A dielectric material of the insulating layer 251 may insulate between lines or patterns of the conductive layer. The insulating layer 251 may be formed of a dielectric material for electrical insulation, such as FR-4.

The substrate 112 may be provided with a protective layer 253 configured to prevent or suppress damage caused by external impact and/or chemical action (e.g., corrosion) and/or optical action.

The protective layer 253 may be configured to cover the first surface of the substrate 112 on which the light emitting diode 210 is mounted. The protective layer 253 may include a photo solder resist (PSR). The protective layer 253 may be formed by applying liquid PSR onto the substrate 112 and curing the PSR. The protective layer 253 may include a first window 253a and a second window 253b. Hereinafter, the first surface of the substrate 112 may refer to the mounting surface of the substrate 112. Based on FIG. 6 and FIG. 7, the first surface of the substrate 112 may refer to an upper surface of the substrate 112, and the second surface of the substrate 112 may refer to a lower surface of the substrate 112.

The power feeding line 230 may be implemented by a line or pattern formed in the conductive layer. The power feeding line 230 may refer to a portion of the conductive layer stacked on the insulation layer 251.

The power feeding pad 240, which is a part of the conductive layer stacked on the insulation layer 251, may be provided to be in contact with the light emitting diode 210. The power feeding pad 240 may be connected to the power feeding line 230. The power feeding pad 240 may be connected to one end of the power feeding line 230. The power feeding pad 240 may refer to one end of the power feeding line 230.

The power feeding pad 240 may include a first power feeding pad 241 provided to apply a positive voltage to the light emitting diode 210, and a second power feeding pad 242 provided to apply a negative voltage to the light emitting diode 210. Alternatively, the first power feeding pad 241 may be provided to apply a negative voltage, and the second power feeding pad 242 may be provided to apply a positive voltage.

The power feeding line 230 may be electrically connected to the light emitting diode 210 through the power feeding pad 240. At least a portion of the power feeding pad 240 may be exposed to the outside through a first window 253a formed in the protective layer 253. The power feeding pad 240 and the light emitting diode 210 may be electrically connected through the at least a portion of the power feeding pad 240 exposed through the first window 253a.

At least a portion of the first power feeding pad 241 may be exposed to the outside through a first window 253a of a protective layer 253. At least a portion of the second power feeding pad 242 may be exposed to the outside through the first window 253a of the protective layer 253. Through the first window 253a, the first power feeding pad 241 may be electrically connected to a first pad of the light emitting diode 210, which will be described later. Through the first window 253a, the second power feeding pad 242 may be electrically connected to a second pad of the light emitting diode 210.

The protective layer 253 may cover the power feeding line 230 so as to prevent the power feeding line 230 from being exposed to the outside. The protective layer 253 may cover a remaining portion of the power feeding pad 240 except for the at least a portion of the power feeding pad 240 exposed through the first window 253a, so as to prevent the remaining portion of the power feeding pad 240 from being exposed to the outside. In other words, the protective layer 253 may expose at least a portion of the power feeding pad 240 to the outside through the first window 253a and may cover the remaining portion of the power feeding pad 240 and the power feeding line 230.

A conductive adhesive material may be applied to the at least a portion of the power feeding pad 240 exposed through the first window 253a to provide electrical contact between an electrode of the light emitting diode 210 and the power feeding pad 240. The conductive adhesive material may be applied to the power feeding pad 240 through the first window 253a of the protective layer 253.

An electrode of the light emitting diode 210 may be in contact with the conductive adhesive material 211, and the light emitting diode 210 may be electrically connected to the power feeding line 230 through the conductive adhesive material 211. For example, the conductive adhesive material may include a solder having electrical conductivity. However, the conductive adhesive material is not limited thereto and may include electrically conductive epoxy adhesives having electrical conductivity.

Power may be supplied to the light emitting diode 210 through the power feeding line 230 and the power feeding pad 240, and the light emitting diode 210 may emit light when power is supplied. A pair of power feeding pads 240 may be provided to correspond to a pair of electrodes of the flip-chip type light emitting diode 210.

The optical dome 220 may be configured to cover at least one light emitting diode 210. According to one or more embodiments, the optical dome 220 may be configured to cover one light emitting diode group 211. The light emitting diode group 211 may include a red light emitting diode 210R, a green light emitting diode 210G, and a blue light emitting diode 210B. The optical dome 220 may be provided to cover the red light emitting diode 210R, the green light emitting diode 210G, and the blue light emitting diode 210B.

The optical dome 220 may prevent or suppress damage to the light emitting diode 210 caused by external mechanical actions and/or chemical actions. The optical dome 220 may also prevent or suppress damage to the light emitting diode group 211 caused by external mechanical actions and/or chemical actions.

According to one or more embodiments, the optical dome 220 may have a dome shape formed by cutting a sphere with a plane not passing through the center, or may have a hemispherical shape formed by cutting a sphere with a plane including the center. A vertical cross section of the optical dome 220 may be, for example, arcuate or semicircular.

The optical dome 220 may be formed of silicone or epoxy resin. For example, molten silicone or epoxy resin may be discharged onto the light emitting diode 210 through a nozzle or the like, and the discharged silicone or epoxy resin may be cured to form the optical dome 220.

Accordingly, the shape of the optical dome 220 may vary depending on the viscosity of the liquid silicone or epoxy resin. For example, when the optical dome 220 is formed using silicone having a thixotropic index of approximately 2.7 to 3.3 (preferably 3.0), a dome ratio (height of the dome/diameter of the base of the dome) of approximately 2.5 to 3.1 (preferably 2.8) may be achieved. For instance, the optical dome 220 formed using silicone having a thixotropic index of approximately 2.7 to 3.3 (preferably 3.0) may have a base diameter of approximately 2.5 mm and a height of approximately 0.7 mm.

The optical dome 220 may be optically transparent or translucent. Light emitted from the light emitting diode 210 may pass through the optical dome 220 and be emitted to the outside.

The dome-shaped optical dome 220 may refract light like a lens. For example, light emitted from the light emitting diode 210 may be refracted by the optical dome 220 and thereby diffused.

As such, the optical dome 220 may not only protect the light emitting diode 210 from external mechanical, chemical, or electrical actions, but may also diffuse light emitted from the light emitting diode 210.

The backlight unit 100 may include an antistatic member 260. The antistatic member 260 may be implemented by a wiring or pattern formed in the conductive layer. In other words, the antistatic member 260 may refer to a portion of the conductive layer stacked on the insulation layer 251. The antistatic member 260 may be spaced apart from the power feeding pad 240 and the power feeding line 230 so as not to be connected thereto.

The protective layer 253 may cover at least a portion of the antistatic member 260 to prevent the at least a portion of the antistatic member 260 from being exposed to the outside. A portion of the antistatic member 260 may be exposed to the outside through a second window 253b of the protective layer 253. The portion of the antistatic member 260 exposed through the second window 253b may capture current generated by electrostatic discharge.

Referring to FIG. 7, a portion of the antistatic member 260 not covered by the protective layer 253 is referred to as an antistatic pad. In other words, a portion of the antistatic member 260 exposed to the outside through the second window 253b of the protective layer 253 is referred to as an antistatic pad.

The antistatic member 260 may include a portion covered by the protective layer 253 and a portion not covered by the protective layer 253 and exposed to the outside, e.g., the antistatic pad. However, at least a portion of the antistatic pad exposed through the protective layer 253 may be covered by the reflective sheet 120.

According to one or more embodiments, the antistatic member 260 may be provided near the optical dome 220 and the power feeding line 230 to protect the light emitting diode 210 from electrostatic discharge. More specifically, the antistatic pad may be provided near the optical dome 220 and the power feeding line 230 to protect the light emitting diode 210 from electrostatic discharge. The antistatic pad may absorb electrical shocks caused by electrostatic discharge occurring near the optical dome 220 and the power feeding line 230.

The optical dome 220 may protect the light emitting diode 210 from external electrical actions. The optical dome 220 may prevent charges generated by electrostatic discharge from passing through the optical dome 220. The optical dome 220 may guide the charge to flow along the outer surface of the optical dome 220. The charge flowing along the outer surface of the optical dome 220 may reach the light emitting diode 210 along the boundary between the optical dome 220 and the substrate 112. The light emitting diode 210 may be damaged due to an electrical shock caused by the charge penetrating along the boundary between the optical dome 220 and the substrate 112. To prevent or suppress such current flow, that is, the flow of charge, the antistatic pad 300 may be provided near the optical dome 220.

The antistatic member 260 may provide a path for current caused by electrostatic discharge generated near the optical dome 220 and the power feeding line 230. In other words, the antistatic member 260 may guide the charge caused by electrostatic discharge to flow toward the ground.

Referring to FIG. 6 and FIG. 7, the substrate 112 may be arranged in parallel with the reflective sheet 120 such that a first surface of the substrate 112 faces the reflective sheet 120. The substrate 112 may include an insulation layer 251 and a conductive layer stacked on the insulation layer 251. A portion of the first surface of the substrate 112 may be the insulation layer 251, and the remaining portion of the first surface may be the conductive layer. In other words, the insulation layer 251 may refer to a partial region of the first surface, and similarly, the conductive layer may refer to another partial region of the first surface.

The power feeding pad 240 may be a part of the conductive layer. The power feeding line 230 may also be a part of the conductive layer. The antistatic member 260 may be a part of the conductive layer. In other words, the conductive layer may include the power feeding pad 240, the power feeding line 230, and the antistatic member 260. The conductive layer may include the power feeding pad 240 and the power feeding line 230 connected to each other, and the antistatic member 260 spaced apart from and not connected to the power feeding pad 240 and the power feeding line 230.

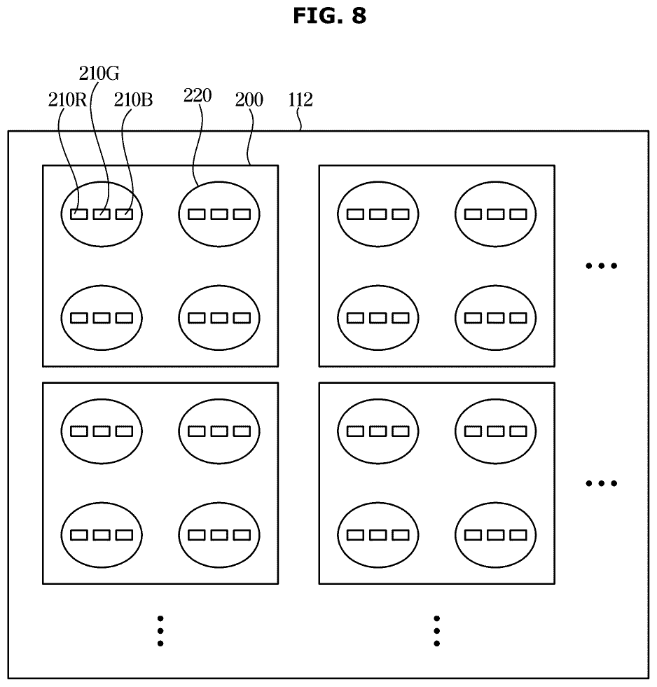

FIG. 8 schematically illustrates dimming blocks according to one or more embodiments.

Referring to FIG. 6, FIG. 7, and FIG. 8, a light emitting diode group 211 may include a red light emitting diode 210R, a green light emitting diode 210G, and a blue light emitting diode 210B. As described above, the three light emitting diodes of one light emitting diode group 211 may be covered by one optical dome 220.

Referring to FIG. 8, in a display apparatus 1 according to one or more embodiments, one dimming block 200 may include four light emitting diode groups. In other words, four light emitting diode groups 211 may form one dimming block 200. However, the number is not limited thereto, and each dimming block may include more than four light emitting diode groups.

The light emitting diodes of each dimming block 200 may be connected to be turned on or off simultaneously. More specifically, the red light emitting diodes 210R of each dimming block 200 may be connected in series with each other; the green light emitting diodes 210G of each dimming block 200 may be connected in series with each other; and the blue light emitting diodes 210B of each dimming block 200 may be connected in series with each other.

As described above, since each light emitting diode group 211 includes the red light emitting diode 210R, the green light emitting diode 210G, and the blue light emitting diode 210B, the display apparatus may have higher color purity and contrast ratio than a display apparatus including only monochromatic light emitting diodes.

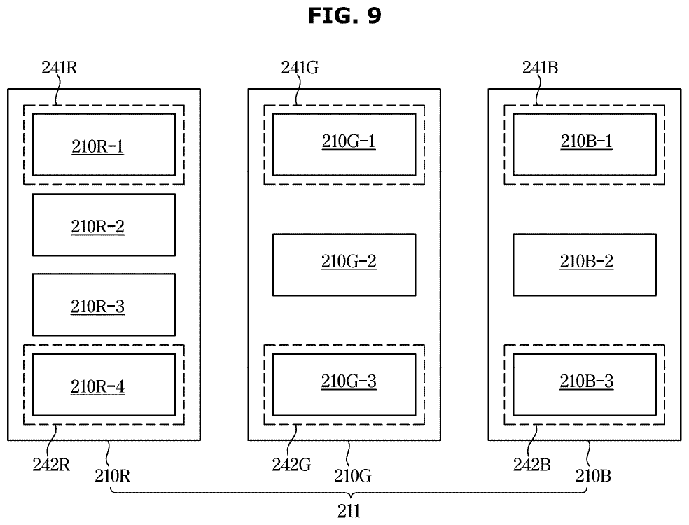

FIG. 9 conceptually illustrates internal structures of light emitting diodes in a light emitting diode group according to one or more embodiments.

Each light emitting diode 210 of the display apparatus 1 according to one or more embodiments may include at least three cells. Each light emitting diode 210 may include at least one cell disposed between a first pad provided to be electrically connected to a first power feeding pad 241 and a second pad provided to be electrically connected to a second power feeding pad 242.

Referring to FIG. 9, a red light emitting diode 210R of each light emitting diode group 211 may include four cells 210R-1, 210R-2, 210R-3, and 210R-4. A green light emitting diode 210G of each light emitting diode group 211 may include three cells 210G-1, 210G-2, and 210G-3. A blue light emitting diode 210B of each light emitting diode group 211 may include three cells 210B-1, 210B-2, and 210B-3.

According to one or more embodiments, the red light emitting diode 210R may include a first pad 241R provided to be electrically connected to the first power feeding pad 241 and a second pad 242R provided to be electrically connected to the second power feeding pad 242. The red light emitting diode 210R may include two cells 210R-2 and 210R-3 disposed between the first pad 241R and the second pad 242R. In this case, a length of a short side of each of the two cells 210R-2 and 210R-3 disposed between the first pad 241R and the second pad 242R may be 100 μm or less.

According to one or more embodiments, the green light emitting diode 210G may include a third pad 241G provided to be electrically connected to a first power feeding pad 241 and a fourth pad 242G provided to be electrically connected to a second power feeding pad 242. The green light emitting diode 210G may include one cell 210G-2 disposed between the third pad 241G and the fourth pad 242G. In this case, a length of a short side of the one cell 210G-2 disposed between the third pad 241G and the fourth pad 242G may be 100 μm or less.

According to one or more embodiments, the blue light emitting diode 210B may include a fifth pad 241B provided to be electrically connected to a first power feeding pad 241 and a sixth pad 242B provided to be electrically connected to a second power feeding pad 242. The blue light emitting diode 210B may include one cell 210B-2 disposed between the fifth pad 241B and the sixth pad 242B. In this case, a length of a short side of the one cell 210B-2 disposed between the fifth pad 241B and the sixth pad 242B may be 100 μm or less.

The sizes of the red light emitting diode 210R, the green light emitting diode 210G, and the blue light emitting diode 210B forming the light emitting diode group 211 may not be the same. For example, the size of the red light emitting diode 210R may be greater than the size of the green light emitting diode 210G, and the size of the red light emitting diode 210R may be greater than the size of the blue light emitting diode 210B.

According to the present disclosure, in each of a plurality of light emitting diode groups 211 forming one dimming block 200, a magnitude of a voltage applied to the red light emitting diode 210R, a magnitude of a voltage applied to the green light emitting diode 210G, and a magnitude of a voltage applied to the blue light emitting diode 210B may be provided to be the same. In other words, a common voltage may be applied to the dimming block 200 regardless of the color of each light emitting diode.

As described above, when the light emitting diodes are driven by applying a common voltage, voltage loss may occur due to differences in the cell driving voltage among the red, green, and blue light emitting diodes. For example, a driving voltage of each of the four cells 210R-1, 210R-2, 210R-3, and 210R-4 included in the red light emitting diode 210R may be 2 V. A driving voltage of each of the three cells 210G-1, 210G-2, and 210G-3 included in the green light emitting diode 210G may be 2.5 V. A driving voltage of each of the three cells 210B-1, 210B-2, and 210B-3 included in the blue light emitting diode 210B may be 2.75 V. However, these driving voltages are theoretical values, and actual driving voltages may differ from the above values.

The four cells 210R-1, 210R-2, 210R-3, and 210R-4 included in the red light emitting diode 210R may be connected in series with each other via bridges inside the red light emitting diode 210R. In addition, in one dimming block 200, the four red light emitting diodes 210R may be connected in series with each other. Accordingly, the total driving voltage of the red light emitting diodes 210R in the dimming block 200 may be 32 V.

The three cells 210G-1, 210G-2, and 210G-3 included in the green light emitting diode 210G may be connected in series with each other via bridges inside the green light emitting diode 210G. In addition, in one dimming block 200, the four green light emitting diodes 210G may be connected in series with each other. Accordingly, the total driving voltage of the green light emitting diodes 210G in the dimming block 200 may be 30 V.

The three cells 210B-1, 210B-2, and 210B-3 included in the blue light emitting diode 210B may be connected in series with each other via bridges inside the blue light emitting diode 210B. In addition, in one dimming block 200, the four blue light emitting diodes 210B may be connected in series with each other. Accordingly, the total driving voltage of the blue light emitting diodes 210B in the dimming block 200 may be 33 V.

As described above, although actual driving voltages may differ from the above values, the driving voltages vary depending on the color of the light emitting diode 210. To apply a common voltage to one dimming block 200 composed of four light emitting diode groups 211, a voltage of 33 V, which is the driving voltage of the blue light emitting diode 210B having the highest voltage requirement among the red, green, and blue light emitting diodes, needs to be applied. In this case, since the red light emitting diode 210R requires a driving voltage of 32 V, a voltage loss of 1 V may occur, and since the green light emitting diode 210G requires a driving voltage of 30 V, a voltage loss of 3 V may occur. That is, a total voltage loss of 4 V may occur. In practice, such voltage loss may be reduced, and the voltage loss may also be reduced compared to a case where the red, green, and blue light emitting diodes include the same number of cells. Furthermore, the voltage loss may be reduced compared to a case where each of the light emitting diodes includes fewer than three cells.

The display apparatus 1 according to one or more embodiments may include a red light emitting diode 210R having four cells, a green light emitting diode 210G having three cells, and a blue light emitting diode 210B having three cells, thereby enabling a common voltage to be applied to the dimming block while reducing voltage loss. Additionally, by driving each of the light emitting diodes 210 at high voltage and low current, the driving efficiency may be improved. Moreover, by driving each of the light emitting diodes 210 at high voltage and low current, the lifetime and color stability of the light emitting diodes may be improved.

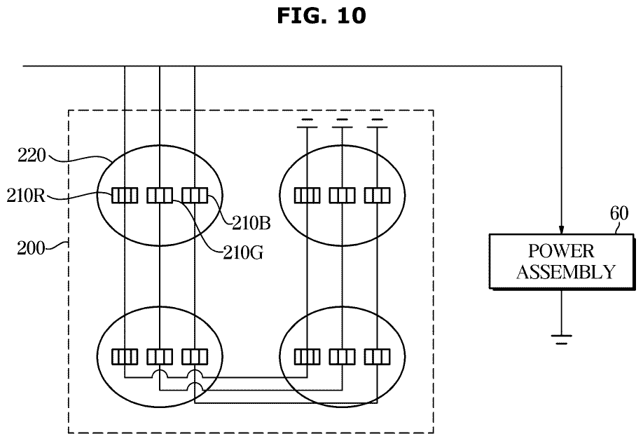

FIG. 10 is a diagram for explaining connection wirings between a power assembly and light emitting diodes according to one or more embodiments.

As described above, each of a plurality of light emitting diode groups 211 included in one dimming block 200 may include a red light emitting diode 210R, a green light emitting diode 210G, and a blue light emitting diode 210B. In this case, the plurality of light emitting diodes may receive current from the same current supply line. In other words, three current supply lines branched from one current supply line connected to a power assembly 60 may supply driving current respectively to the red light emitting diodes 210R, the green light emitting diodes 210G, and the blue light emitting diodes 210B.

Referring to FIG. 10, the one current supply line connected to the power assembly 60 may be connected to the current supply line that supplies driving current to the red light emitting diodes 210R. Likewise, the one current supply line connected to the power assembly 60 may be connected to the current supply line that supplies driving current to the green light emitting diodes 210G. The another current supply line connected to the power assembly 60 may be connected to the current supply line that supplies driving current to the blue light emitting diodes 210B.

The current supplied to the red light emitting diode 210R may be divided into four parts to flow through each of the cells 210R-1, 210R-2, 210R-3, and 210R-4. The current supplied to the green light emitting diode 210G may be divided into three parts to flow through each of the cells 210G-1, 210G-2, and 210G-3. The current supplied to the blue light emitting diode 210B may be divided into three parts to flow through each of the cells 210B-1, 210B-2, and 210B-3. Accordingly, each cell may be driven by relatively low current, and the driving efficiency of the display apparatus 1 may be improved.

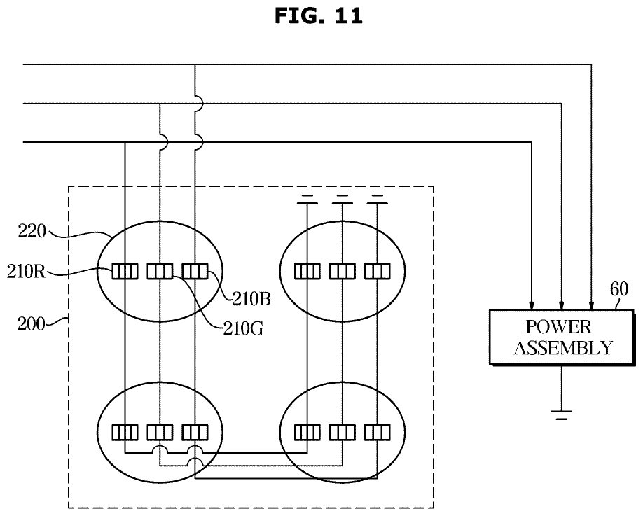

FIG. 11 is a diagram for explaining connection wirings between a power assembly and light emitting diodes according to one or more embodiments.

Referring to FIG. 11, one of three current supply lines connected to the power assembly 60 may be connected to a current supply line that supplies driving current to the red light emitting diodes 210R. Another one of the three current supply lines connected to the power assembly 60 may be connected to a current supply line that supplies driving current to the green light emitting diodes 210G. The remaining one of the three current supply lines connected to the power assembly 60 may be connected to a current supply line that supplies driving current to the blue light emitting diodes 210B.

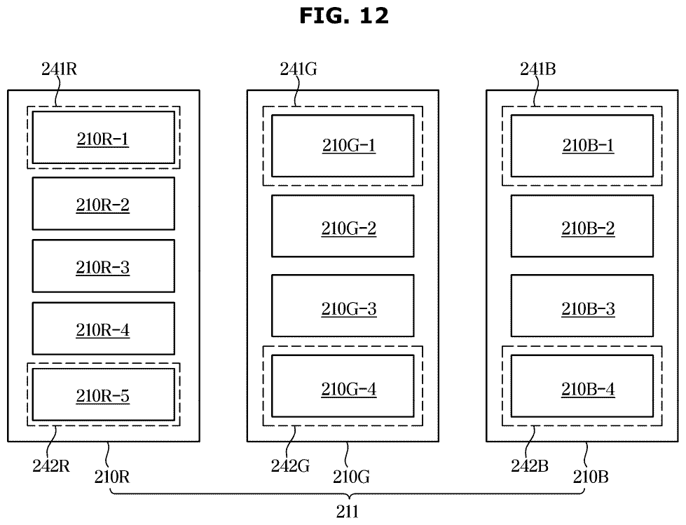

FIG. 12 conceptually illustrates internal structures of light emitting diodes in a light emitting diode group according to one or more embodiments.

Referring to FIG. 12, the red light emitting diode 210R of each light emitting diode group 211 according to one or more embodiments may include five cells 210R-1, 210R-2, 210R-3, 210R-4, and 210R-5. The green light emitting diode 210G of each light emitting diode group 211 may include four cells 210G-1, 210G-2, 210G-3, and 210G-4. The blue light emitting diode 210B of each light emitting diode group 211 may include four cells 210B-1, 210B-2, 210B-3, and 210B-4.

According to one or more embodiments, the red light emitting diode 210R may include a first pad 241R provided to be electrically connected to a first power feeding pad 241, and a second pad 242R provided to be electrically connected to a second power feeding pad 242. The red light emitting diode 210R may include three cells 210R-2, 210R-3, and 210R-4 disposed between the first pad 241R and the second pad 242R. In this case, each of the three cells 210R-2, 210R-3, and 210R-4 disposed between the first pad 241R and the second pad 242R may have a short side length of 100 μm or less.

According to one or more embodiments, the green light emitting diode 210G may include a third pad 241G provided to be electrically connected to a first power feeding pad 241, and a fourth pad 242G provided to be electrically connected to a second power feeding pad 242. The green light emitting diode 210G may include two cells 210G-2 and 210G-3 disposed between the third pad 241G and the fourth pad 242G. In this case, each of the two cells 210G-2 and 210G-3 disposed between the third pad 241G and the fourth pad 242G may have a short side length of 100 μm or less.

According to one or more embodiments, the blue light emitting diode 210B may include a fifth pad 241B provided to be electrically connected to a first power feeding pad 241, and a sixth pad 242B provided to be electrically connected to a second power feeding pad 242. The blue light emitting diode 210B may include two cells 210B-2 and 210B-3 disposed between the fifth pad 241B and the sixth pad 242B. In this case, each of the two cells 210B-2 and 210B-3 disposed between the fifth pad 241B and the sixth pad 242B may have a short side length of 100 μm or less.

The sizes of the red light emitting diode 210R, the green light emitting diode 210G, and the blue light emitting diode 210B constituting the light emitting diode group 211 may differ from each other. For example, the size of the red light emitting diode 210R may be greater than that of the green light emitting diode 210G. The size of the red light emitting diode 210R may also be greater than that of the blue light emitting diode 210B.

According to the present disclosure, in each of the plurality of light emitting diode groups 211 forming a dimming block 200, the magnitude of voltage applied to the red light emitting diode 210R, the magnitude of voltage applied to the green light emitting diode 210G, and the magnitude of voltage applied to the blue light emitting diode 210B may be the same. In other words, a common voltage may be applied to all light emitting diodes in a dimming block 200 regardless of their colors.

As described above, when a common voltage is applied to drive the light emitting diodes, voltage loss may occur due to different driving voltages of the cells of the red, green, and blue light emitting diodes. For example, each of the five cells 210R-1, 210R-2, 210R-3, 210R-4, and 210R-5 of the red light emitting diode 210R may have a driving voltage of 2 V. Each of the four cells 210G-1, 210G-2, 210G-3, and 210G-4 of the green light emitting diode 210G may have a driving voltage of 2.5 V. Each of the four cells 210B-1, 210B-2, 210B-3, and 210B-4 of the blue light emitting diode 210B may have a driving voltage of 2.75 V. However, the above values are theoretical and the actual driving voltage may differ.

The five cells 210R-1, 210R-2, 210R-3, 210R-4, and 210R-5 included in the red light emitting diode 210R may be connected in series through internal bridges of the red light emitting diode 210R. Also, four red light emitting diodes 210R in one dimming block 200 may be connected in series. Therefore, the total driving voltage of the red light emitting diodes 210R in the one dimming block 200 may be 40 V.

The four cells 210G-1, 210G-2, 210G-3, and 210G-4 included in the green light emitting diode 210G may be connected in series through internal bridges of the green light emitting diode 210G. Also, four green light emitting diodes 210G in one dimming block 200 may be connected in series. Therefore, the total driving voltage of the green light emitting diodes 210G in the one dimming block 200 may be 40 V.

The four cells 210B-1, 210B-2, 210B-3, and 210B-4 included in the blue light emitting diode 210B may be connected in series through internal bridges of the blue light emitting diode 210B. Also, four blue light emitting diodes 210B in one dimming block 200 may be connected in series. Therefore, the total driving voltage of the blue light emitting diodes 210B in the one dimming block 200 may be 44 V.

As described above, although actual driving voltages may differ from the above values, there may be a difference in driving voltages depending on the color of the light emitting diode 210. In order to apply a common voltage to a dimming block 200 including four light emitting diode groups 211, a voltage of 44 V, which is the highest driving voltage among the red, green, and blue light emitting diodes, need to be applied. In this case, since the red light emitting diodes 210R require 40 V, a voltage loss of 4 V occurs, and since the green light emitting diodes 210G also require 40 V, another 4 V loss occurs, resulting in a total voltage loss of 8 V. This voltage loss may be reduced in actual implementations. Also, the voltage loss may be reduced compared to a case where the numbers of cells of the red, green, and blue light emitting diodes are all the same.

According to one or more embodiments, the display apparatus 1 may include a red light emitting diode 210R having five cells and green and blue light emitting diodes 210G and 210B each having four cells, thereby reducing voltage loss while applying a common voltage to the dimming block. In addition, each light emitting diode 210 may be driven by high voltage and low current to improve driving efficiency. Moreover, driving each light emitting diode 210 with high voltage and low current may enhance the lifetime and color stability of the light emitting diode.

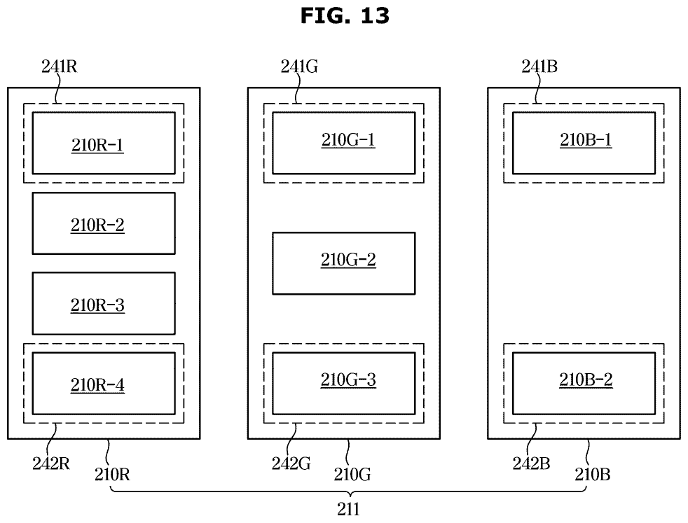

FIG. 13 conceptually illustrates internal structures of light emitting diodes in a light emitting diode group according to one or more embodiments.

Referring to FIG. 13, the red light emitting diode 210R of each light emitting diode group 211 according to one or more embodiments may include four cells 210R-1, 210R-2, 210R-3, and 210R-4. The green light emitting diode 210G of each light emitting diode group 211 may include three cells 210G-1, 210G-2, and 210G-3. The blue light emitting diode 210B of each light emitting diode group 211 may include two cells 210B-1 and 210B-2.

According to one or more embodiments, the red light emitting diode 210R may include a first pad 241R provided to be electrically connected to a first power feeding pad 241, and a second pad 242R provided to be electrically connected to a second power feeding pad 242. The red light emitting diode 210R may include two cells 210R-2 and 210R-3 disposed between the first pad 241R and the second pad 242R. In this case, each of the two cells 210R-2 and 210R-3 disposed between the first pad 241R and the second pad 242R may have a short side length of 100 μm or less.

According to one or more embodiments, the green light emitting diode 210G may include a third pad 241G provided to be electrically connected to a first power feeding pad 241, and a fourth pad 242G provided to be electrically connected to a second power feeding pad 242. The green light emitting diode 210G may include a single cell 210G-2 disposed between the third pad 241G and the fourth pad 242G. In this case, the single cell 210G-2 disposed between the third pad 241G and the fourth pad 242G may have a short side length of 100 μm or less.

According to one or more embodiments, the blue light emitting diode 210B may include a fifth pad 241B provided to be electrically connected to a first power feeding pad 241, and a sixth pad 242B provided to be electrically connected to a second power feeding pad 242. The blue light emitting diode 210B may not include any cell disposed between the fifth pad 241B and the sixth pad 242B.

The sizes of the red light emitting diode 210R, the green light emitting diode 210G, and the blue light emitting diode 210B constituting the light emitting diode group 211 may be different from one another. For example, the size of the red light emitting diode 210R may be greater than that of the green light emitting diode 210G. The size of the red light emitting diode 210R may also be greater than that of the blue light emitting diode 210B.

According to the present disclosure, in each of the plurality of light emitting diode groups 211 forming a dimming block 200, the magnitude of voltage applied to the red light emitting diode 210R, the magnitude of voltage applied to the green light emitting diode 210G, and the magnitude of voltage applied to the blue light emitting diode 210B may be the same. In other words, a common voltage may be applied to all of the light emitting diodes in a dimming block 200 regardless of their colors.

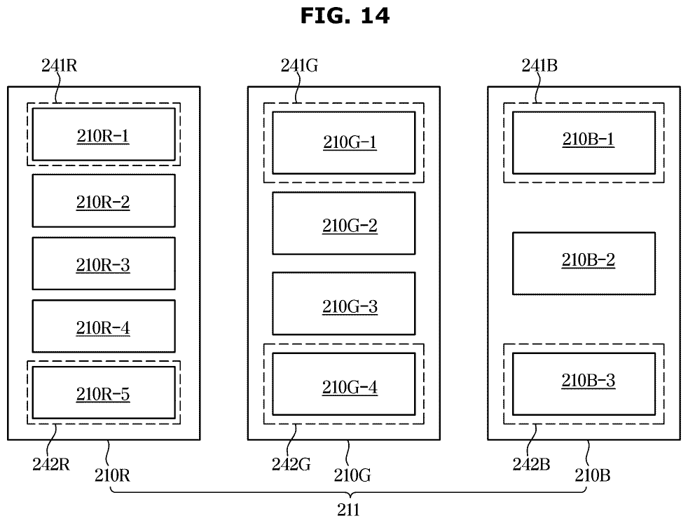

FIG. 14 conceptually illustrates internal structures of light emitting diodes in a light emitting diode group according to one or more embodiments.

Referring to FIG. 14, the red light emitting diode 210R of each light emitting diode group 211 according to one or more embodiments may include five cells 210R-1, 210R-2, 210R-3, 210R-4, and 210R-5. The green light emitting diode 210G of each light emitting diode group 211 may include four cells 210G-1, 210G-2, 210G-3, and 210G-4. The blue light emitting diode 210B of each light emitting diode group 211 may include three cells 210B-1, 210B-2, and 210B-3.

According to one or more embodiments, the red light emitting diode 210R may include a first pad 241R provided to be electrically connected to a first power feeding pad 241, and a second pad 242R provided to be electrically connected to a second power feeding pad 242. The red light emitting diode 210R may include three cells 210R-2, 210R-3, and 210R-4 disposed between the first pad 241R and the second pad 242R. In this case, each of the three cells 210R-2, 210R-3, and 210R-4 disposed between the first pad 241R and the second pad 242R may have a short side length of 100 μm or less.

According to one or more embodiments, the green light emitting diode 210G may include a third pad 241G provided to be electrically connected to a first power feeding pad 241, and a fourth pad 242G provided to be electrically connected to a second power feeding pad 242. The green light emitting diode 210G may include two cells 210G-2 and 210G-3 disposed between the third pad 241G and the fourth pad 242G. In this case, each of the two cells 210G-2 and 210G-3 may have a short side length of 100 μm or less.

According to one or more embodiments, the blue light emitting diode 210B may include a fifth pad 241B provided to be electrically connected to a first power feeding pad 241, and a sixth pad 242B provided to be electrically connected to a second power feeding pad 242. The blue light emitting diode 210B may include a single cell 210B-2 disposed between the fifth pad 241B and the sixth pad 242B. In this case, the single cell 210B-2 may have a short side length of 100 μm or less.

The sizes of the red light emitting diode 210R, the green light emitting diode 210G, and the blue light emitting diode 210B constituting the light emitting diode group 211 may differ from one another. For example, the red light emitting diode 210R may be larger in size than the green light emitting diode 210G. The red light emitting diode 210R may also be larger than the blue light emitting diode 210B.

According to the present disclosure, in each of the plurality of light emitting diode groups 211 forming a dimming block 200, the magnitude of the voltage applied to the red light emitting diode 210R, the magnitude of voltage applied to the green light emitting diode 210G, and the magnitude of voltage applied to the blue light emitting diode 210B may be the same. In other words, a common voltage may be applied to the light emitting diodes of a dimming block 200 regardless of their colors.

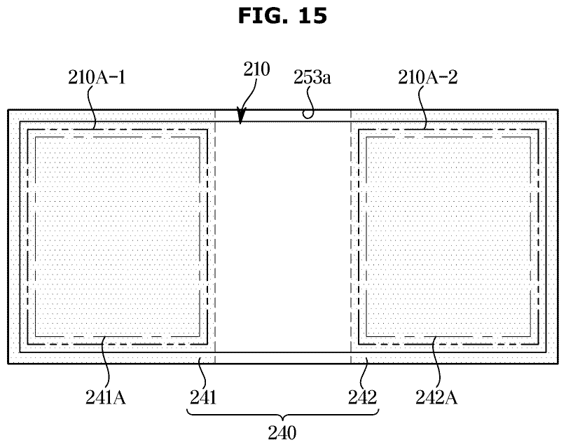

FIG. 15 illustrates a light emitting diode including two cells in a display apparatus according to one or more embodiments.

FIG. 15 illustrates a first window 253a of a protective layer 253, at least a portion of a first power feeding pad 241 and at least a portion of a second power feeding pad 242 that are exposed through the first window 253a, a light emitting diode 210 mounted on a substrate 112 through the first window 253a, a first pad 241A and a second pad 242A of the light emitting diode 210, and a first cell 210A-1 and a second cell 210A-2 of the light emitting diode 210.

Referring to FIG. 15, the light emitting diode 210 may include two cells. The first pad 241A of the light emitting diode 210 may be electrically connected to the first power feeding pad 241 exposed through the first window 253a of the protective layer 253. The second pad 242A of the light emitting diode 210 may be electrically connected to the second power feeding pad 242 exposed through the first window 253a of the protective layer 253.

In the case where the light emitting diode 210 includes two cells, there may be no cell between the first pad 241A and the second pad 242A of the light emitting diode 210.

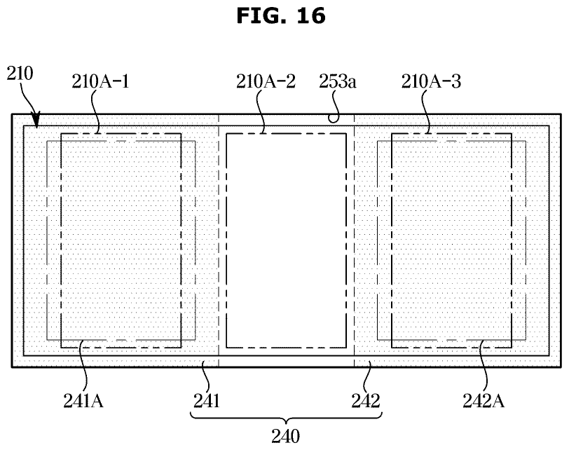

FIG. 16 illustrates a light emitting diode including three cells in a display apparatus according to one or more embodiments.

FIG. 16 illustrates a first window 253a of a protective layer 253, at least a portion of a first power feeding pad 241 and at least a portion of a second power feeding pad 242 that are exposed through the first window 253a, a light emitting diode 210 mounted on a substrate 112 through the first window 253a, a first pad 241A and a second pad 242A of the light emitting diode 210, and first to third cells 210A-1, 210A-2, and 210A-3 of the light emitting diode 210.

Referring to FIG. 16, the light emitting diode 210 may include three cells. The first pad 241A of the light emitting diode 210 may be electrically connected to the first power feeding pad 241 exposed through the first window 253a of the protective layer 253. The second pad 242A of the light emitting diode 210 may be electrically connected to the second power feeding pad 242 exposed through the first window 253a of the protective layer 253.

In the case where the light emitting diode 210 includes three cells, one cell 210A-2 may be provided between the first pad 241A and the second pad 242A of the light emitting diode 210.

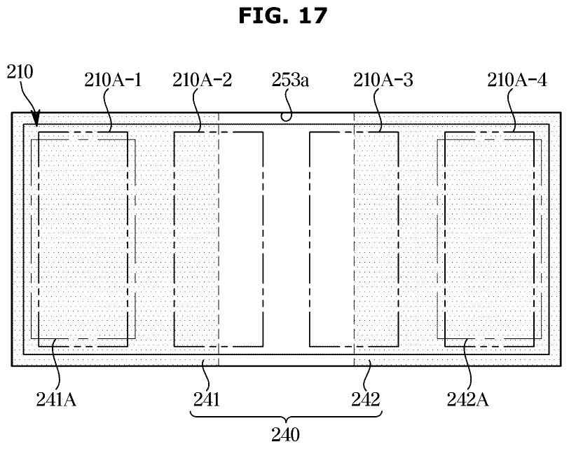

FIG. 17 illustrates a light emitting diode including four cells in a display apparatus according to one or more embodiments.

FIG. 17 illustrates a first window 253a of a protective layer 253, at least a portion of a first power feeding pad 241 and at least a portion of a second power feeding pad 242 that are exposed through the first window 253a, a light emitting diode 210 mounted on a substrate 112 through the first window 253a, a first pad 241A and a second pad 242A of the light emitting diode 210, and first to fourth cells 210A-1, 210A-2, 210A-3, and 210A-4 of the light emitting diode 210.

Referring to FIG. 17, the light emitting diode 210 may include four cells. The first pad 241A of the light emitting diode 210 may be electrically connected to the first power feeding pad 241 exposed through the first window 253a of the protective layer 253. The second pad 242A of the light emitting diode 210 may be electrically connected to the second power feeding pad 242 exposed through the first window 253a of the protective layer 253.

In the case where the light emitting diode 210 includes four cells, two cells 210A-2 and 210A-3 may be provided between the first pad 241A and the second pad 242A of the light emitting diode 210.

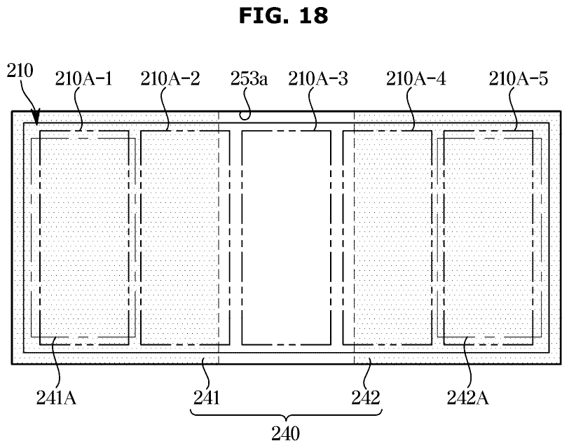

FIG. 18 illustrates a light emitting diode including five cells in a display apparatus according to one or more embodiments.

FIG. 18 illustrates a first window 253a of a protective layer 253, at least a portion of a first power feeding pad 241 and at least a portion of a second power feeding pad 242 that are exposed through the first window 253a, a light emitting diode 210 mounted on a substrate 112 through the first window 253a, a first pad 241A and a second pad 242A of the light emitting diode 210, and first to fifth cells 210A-1, 210A-2, 210A-3, 210A-4, and 210A-5 of the light emitting diode 210.

Referring to FIG. 18, the light emitting diode 210 may include five cells. The first pad 241A of the light emitting diode 210 may be electrically connected to the first power feeding pad 241 exposed through the first window 253a of the protective layer 253. The second pad 242A of the light emitting diode 210 may be electrically connected to the second power feeding pad 242 exposed through the first window 253a of the protective layer 253.

In the case where the light emitting diode 210 includes five cells, three cells 210A-2, 210A-3, and 210A-4 may be provided between the first pad 241A and the second pad 242A of the light emitting diode 210.

The size of the light emitting diode 210 may vary depending on the number of cells included in the light emitting diode 210. For example, the size of the light emitting diode 210 may increase as the number of included cells increases.

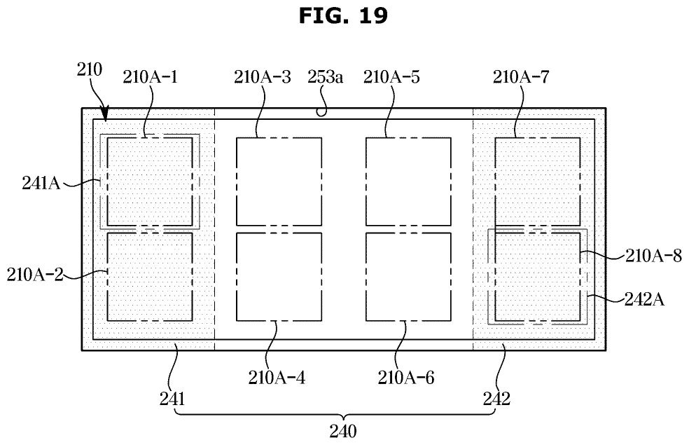

FIG. 19 illustrates a light emitting diode including eight cells in a display apparatus according to one or more embodiments.

FIG. 19 illustrates a first window 253a of a protective layer 253 and at least a portion of a first power feeding pad 241 and at least a portion of a second power feeding pad 242 that are exposed through the first window 253a. FIG. 19 also illustrates a light emitting diode 210 mounted on a substrate 112 through the first window 253a, a first pad 241A and a second pad 242A of the light emitting diode 210, and first to eighth cells 210A-1, 210A-2, 210A-3, 210A-4, 210A-5, 210A-6, 210A-7, and 210A-8 of the light emitting diode 210.

Referring to FIG. 19, the light emitting diode 210 may include eight cells. The first pad 241A of the light emitting diode 210 may be electrically connected to the first power feeding pad 241 exposed through the first window 253a of the protective layer 253. The second pad 242A of the light emitting diode 210 may be electrically connected to the second power feeding pad 242 exposed through the first window 253a of the protective layer 253.

The first pad 241A of the light emitting diode 210 may be disposed adjacent to one end of the first power feeding pad 241. As shown in FIG. 19, the first pad 241A may be disposed adjacent to an upper end of the first power feeding pad 241 based on the drawing.

The second pad 242A of the light emitting diode 210 may be disposed adjacent to the other end of the second power feeding pad 242. As shown in FIG. 19, the second pad 242A may be disposed adjacent to a lower end of the second power feeding pad 242 based on the drawing.

According to one or more embodiments, the first pad 241A of the light emitting diode 210 may be disposed adjacent to the other end of the first power feeding pad 241, and the second pad 242A of the light emitting diode 210 may be disposed adjacent to one end of the second power feeding pad 242. For example, the first pad 241A may be disposed adjacent to a lower end of the first power feeding pad 241 based on the drawing, and the second pad 242A may be disposed adjacent to an upper end of the second power feeding pad 242 based on the drawing.

As described above, by disposing the first pad 241A of the light emitting diode 210 adjacent to one end or the other end of the first power feeding pad 241, and disposing the second pad 242A of the light emitting diode 210 adjacent to the other end or one end of the second power feeding pad 242, tilting of the light emitting diode 210 may be prevented or reduced. When the first pad 241A and the second pad 242A are disposed adjacent to respective one ends of the first power feeding pad 241 and the second power feeding pad 242, or adjacent to respective other ends of the first power feeding pad 241 and the second power feeding pad 242, the light emitting diode 210 may be mounted in a tilted manner toward the one ends or the other ends of the power feeding pads 241 and 242.

Referring to FIG. 19, a first cell 210A-1 may be provided on the first pad 241A of the light emitting diode 210, and an eighth cell 210A-8 may be provided on the second pad 242A of the light emitting diode 210. The light emitting diode 210 may include a second cell 210A-2 provided on a region of the first power feeding pad 241 in which the first pad 241A is not provided. The light emitting diode 210 may include a seventh cell 210A-7 provided on a region of the second power feeding pad 242 in which the second pad 242A is not provided.

According to one or more embodiments, four cells 210A-3, 210A-4, 210A-5, and 210A-6 may be provided between the first power feeding pad 241 and the second power feeding pad 242. The four cells may be arranged in a 2×2 matrix form. However, the arrangement is not limited thereto. Two cells or six or more cells may be provided between the first power feeding pad 241 and the second power feeding pad 242. When two cells are provided, the two cells may be arranged in a 2×1 matrix form. When six cells are provided, the six cells may be arranged in a 2×3 matrix form.

The size of the light emitting diode 210 may vary depending on the number of cells included in the light emitting diode 210. For example, as the number of included cells increases, the size of the light emitting diode 210 may increase.

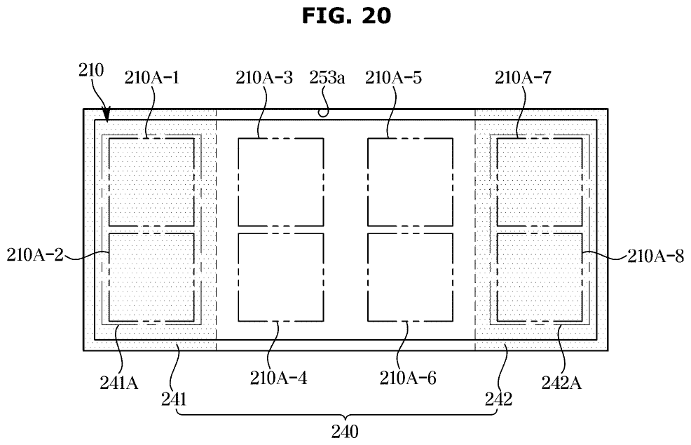

FIG. 20 illustrates a light emitting diode including eight cells in a display apparatus according to one or more embodiments.

FIG. 20 illustrates a first window 253a of a protective layer 253, at least a portion of a first power feeding pad 241 and at least a portion of a second power feeding pad 242 that are exposed through the first window 253a. FIG. 20 also illustrates a light emitting diode 210 mounted on a substrate 112 through the first window 253a, a first pad 241A and a second pad 242A of the light emitting diode 210, and a first cell 210A-1, a second cell 210A-2, a third cell 210A-3, a fourth cell 210A-4, a fifth cell 210A-5, a sixth cell 210A-6, a seventh cell 210A-7, and an eighth cell 210A-8 of the light emitting diode 210.

Referring to FIG. 20, the light emitting diode 210 may include eight cells. The first pad 241A of the light emitting diode 210 may be electrically connected to the first power feeding pad 241 exposed through the first window 253a of the protective layer 253. The second pad 242A of the light emitting diode 210 may be electrically connected to the second power feeding pad 242 exposed through the first window 253a of the protective layer 253.

The first pad 241A of the light emitting diode 210 may extend from one end to the other end of the first power feeding pad 241. The first pad 241A may be smaller than the first power feeding pad 241. One end of the first pad 241A may be adjacent to one end of the first power feeding pad 241, and the other end of the first pad 241A may be adjacent to the other end of the first power feeding pad 241.

The second pad 242A of the light emitting diode 210 may extend from one end to the other end of the second power feeding pad 242. The second pad 242A may be smaller than the second power feeding pad 242. One end of the second pad 242A may be adjacent to one end of the second power feeding pad 242, and the other end of the second pad 242A may be adjacent to the other end of the second power feeding pad 242.

As described above, since the first pad 241A of the light emitting diode 210 extends from a position adjacent to one end of the first power feeding pad 241 to a position adjacent to the other end of the first power feeding pad 241 and the second pad 242A of the light emitting diode 210 extends from a position adjacent to one end of the second power feeding pad 242 to a position adjacent to the other end of the second power feeding pad 242, tilting of the light emitting diode 210 may be prevented or reduced. When the first pad 241A and the second pad 242A are respectively disposed adjacent to one ends of the first power feeding pad 241 and the second power feeding pad 242 or respectively disposed adjacent to the other ends of the first power feeding pad 241 and the second power feeding pad 242, the light emitting diode 210 may be mounted while being tilted toward the other ends or the one ends of the first power feeding pad 241 and the second power feeding pad 242.

Referring to FIG. 20, the first and second cells 210A-1 and 210A-2 may be provided on the first pad 241A of the light emitting diode 210, and the seventh and eighth cells 210A-7 and 210A-8 may be provided on the second pad 242A of the light emitting diode 210.

According to one or more embodiments, four cells 210A-3, 210A-4, 210A-5, and 210A-6 may be provided between the first power feeding pad 241 and the second power feeding pad 242, or between the first pad 241A and the second pad 242A. The four cells 210A-3, 210A-4, 210A-5, and 210A-6 may be arranged in a 2×2 matrix form. However, the configuration is not limited thereto. Two cells or six or more cells may be provided between the first power feeding pad 241 and the second power feeding pad 242 or between the first pad 241A and the second pad 242A. When two cells are provided, the two cells may be arranged in a 2×1 matrix form. When six cells are provided, the six cells may be arranged in a 2×3 matrix form.

The size of the light emitting diode 210 may vary depending on the number of cells included therein. For example, as the number of cells included in the light emitting diode 210 increases, the size of the light emitting diode 210 may increase accordingly.

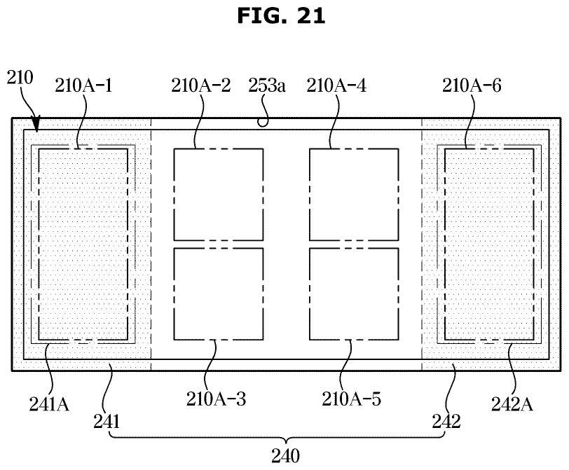

FIG. 21 illustrates a light emitting diode including six cells in a display apparatus according to one or more embodiments.

FIG. 21 illustrates a first window 253a of a protective layer 253, at least a portion of a first power feeding pad 241 exposed through the first window 253a, and at least a portion of a second power feeding pad 242 exposed through the first window 253a. FIG. 21 also illustrates a light emitting diode 210 mounted on a substrate 112 through the first window 253a, a first pad 241A and a second pad 242A of the light emitting diode 210, and a first cell 210A-1, a second cell 210A-2, a third cell 210A-3, a fourth cell 210A-4, a fifth cell 210A-5, and a sixth cell 210A-6 of the light emitting diode 210.

Referring to FIG. 21, the light emitting diode 210 may include six cells. The first pad 241A of the light emitting diode 210 may be electrically connected to the first power feeding pad 241 exposed through the first window 253a of the protective layer 253. The second pad 242A of the light emitting diode 210 may be electrically connected to the second power feeding pad 242 exposed through the first window 253a of the protective layer 253.

The first pad 241A of the light emitting diode 210 may extend from one end to the other end of the first power feeding pad 241. The first pad 241A may be provided to be smaller than the first power feeding pad 241. One end of the first pad 241A may be adjacent to one end of the first power feeding pad 241, and the other end of the first pad 241A may be adjacent to the other end of the first power feeding pad 241.

The second pad 242A of the light emitting diode 210 may extend from one end to the other end of the second power feeding pad 242. The second pad 242A may be provided to be smaller than the second power feeding pad 242. One end of the second pad 242A may be adjacent to one end of the second power feeding pad 242, and the other end of the second pad 242A may be adjacent to the other end of the second power feeding pad 242.

As described above, the first pad 241A of the light emitting diode 210 may extend from a position adjacent to one end of the first power feeding pad 241 to a position adjacent to the other end thereof, and the second pad 242A of the light emitting diode 210 may extend from a position adjacent to one end of the second power feeding pad 242 to a position adjacent to the other end thereof, thereby preventing or reducing tilting of the light emitting diode 210. When the first pad 241A and the second pad 242A are respectively disposed adjacent to one ends of the first power feeding pad 241 and the second power feeding pad 242, or are respectively disposed adjacent to the other ends of the first power feeding pad 241 and the second power feeding pad 242, the light emitting diode 210 may be mounted to tilt toward the other ends of the first power feeding pad 241 and the second power feeding pad 242, or toward the one ends thereof.

Referring to FIG. 21, the first cell 210A-1 may be provided on the first pad 241A of the light emitting diode 210, and the sixth cell 210A-6 may be provided on the second pad 242A of the light emitting diode 210. The first cell 210A-1 may be provided to correspond to the first pad 241A, and the sixth cell 210A-6 may be provided to correspond to the second pad 242A. When the first cell 210A-1 is referred to as corresponding to the first pad 241A, it means that the first cell 210A-1 and the first pad 241A are formed with similar size and shape. Likewise, when the sixth cell 210A-6 is referred to as corresponding to the second pad 242A, it means that the sixth cell 210A-6 and the second pad 242A are formed with similar size and shape.

According to one or more embodiments, four cells 210A-2, 210A-3, 210A-4, and 210A-5 may be provided between the first power feeding pad 241 and the second power feeding pad 242, or between the first pad 241A and the second pad 242A, or between the cell 210A-1 and the cell 210A-6. The four cells 210A-2, 210A-3, 210A-4, and 210A-5 may be arranged in a 2×2 matrix. However, the arrangement is not limited thereto. Two cells or six or more cells may be provided between the first power feeding pad 241 and the second power feeding pad 242, or between the first pad 241A and the second pad 242A, or between the first cell 210A-1 and the sixth cell 210A-6. When two cells are provided, the two cells may be arranged in a 2×1 matrix, and when six cells are provided, the six cells may be arranged in a 2×3 matrix.

The size of the light emitting diode 210 may vary depending on the number of cells included in the light emitting diode 210. For example, as the number of cells included in the light emitting diode 210 increases, the size of the light emitting diode 210 may increase.

In FIG. 15, FIG. 16, FIG. 17, FIG. 18, FIG. 19, FIG. 20, and FIG. 21, the size of the light emitting diode 210 is illustrated to be smaller than the size of the first window 253a of the protective layer 253, but embodiments of the disclosure are not limited thereto. The size of the light emitting diode 210 may be larger than the size of the first window 253a. However, even when the size of the light emitting diode 210 is larger than the size of the first window 253a, the first pad 241A and the second pad 242A of the light emitting diode 210 may still be positioned inside the first window 253a.

A display apparatus according to one or more embodiments includes a liquid crystal panel and a backlight unit configured to provide light to the liquid crystal panel. The backlight unit includes a substrate, a red light emitting diode configured to be mounted on a first surface of the substrate, a green light emitting diode configured to be mounted on the first surface of the substrate and a blue light emitting diode configured to be mounted on the first surface of the substrate. Each of the red light emitting diode, the green light emitting diode, and the blue light emitting diode may include at least two cells.

The red light emitting diode may include four cells.

Each of the green light emitting diode and the blue light emitting diode may include three cells.

The red light emitting diode may include five cells.

Each of the green light emitting diode and the blue light emitting diode may include four cells.

The display apparatus may further include a plurality of light emitting diode groups arranged in a plurality of rows and a plurality of columns on the substrate, each of the plurality of light emitting diode groups including the red light emitting diode, the green light emitting diode, and the blue light emitting diode.

The display apparatus may further include a dimming block including light emitting diode groups among the plurality of light emitting diode groups that are connected to be turned on or off simultaneously.

Each of the light emitting diode groups of the dimming block, a magnitude of a voltage applied to the red light emitting diode, a magnitude of a voltage applied to the green light emitting diode, and a magnitude of a voltage applied to the blue light emitting diode may be provided to be the same.

The display apparatus may further include a reflective sheet having a plurality of holes, each of which accommodates a respective one of the plurality of light emitting diode groups, and configured to cover the one surface of the substrate.

The display apparatus may further include a plurality of optical domes, each provided inside a respective one of the plurality of holes and configured to cover a corresponding one of the plurality of light emitting diode groups.

The display apparatus may further include a first power feeding pad formed as a part of the conductive layer forming at least a portion of the one surface of the substrate, provided to apply a positive voltage to the red light emitting diode, the green light emitting diode, and the blue light emitting diode.

The display apparatus may further include a second power feeding pad formed as a part of the conductive layer, provided to apply a negative voltage to the red light emitting diode, the green light emitting diode, and the blue light emitting diode.

The red light emitting diode may include a first pad provided to be electrically connected to the first power feeding pad, and a second pad provided to be electrically connected to the second power feeding pad.

The green light emitting diode may include a third pad provided to be electrically connected to the first power feeding pad, and a fourth pad provided to be electrically connected to the second power feeding pad.

The blue light emitting diode may include a fifth pad provided to be electrically connected to the first power feeding pad, and a sixth pad provided to be electrically connected to the second power feeding pad.

The red light emitting diode may include two cells disposed between the first pad and the second pad.

The green light emitting diode may include one cell disposed between the third pad and the fourth pad.

The blue light emitting diode may include one cell disposed between the fifth pad and the sixth pad.

The red light emitting diode may include three cells disposed between the first pad and the second pad.

The green light emitting diode may include two cells disposed between the third pad and the fourth pad.

The blue light emitting diode may include two cells disposed between the fifth pad and the sixth pad.

A length of a short side of each of the two cells disposed between the first pad and the second pad of the red light emitting diode may be 100 μm or less.

A length of a short side of the one cell disposed between the third pad and the fourth pad of the green light emitting diode may be 100 μm or less.

A length of a short side of the one cell disposed between the fifth pad and the sixth pad of the blue light emitting diode may be 100 μm or less.

A display apparatus according to one or more embodiments includes a liquid crystal panel and a backlight unit configured to provide light to the liquid crystal panel. The backlight unit includes a substrate including an insulating layer and a conductive layer, a light emitting diode mounted on the substrate and including a first pad provided to correspond to a anode and a second pad provided to correspond to a cathode, a first power feeding pad as a part of the conductive layer, provided to connect a positive electrode to the first pad and a second power feeding pad as a part of the conductive layer, provided to connect a negative electrode to the second pad. The light emitting diode may include at least one cell disposed between the first pad and the second pad.

The light emitting diode may be one of a red light emitting diode, a green light emitting diode, and a blue light emitting diode.

The red light emitting diode may include two cells disposed between the first pad and the second pad.

The green light emitting diode may include one cell disposed between the first pad and the second pad.

The blue light emitting diode may include one cell disposed between the first pad and the second pad.

A length of a short side of each of the two cells disposed between the first pad and the second pad of the red light emitting diode may be 100 μm or less.

A length of a short side of the one cell disposed between the first pad and the second pad of the green light emitting diode may be 100 μm or less.

A length of a short side of the one cell disposed between the first pad and the second pad of the blue light emitting diode may be 100 μm or less.

The red light emitting diode may include four cells.

Each of the green light emitting diode and the blue light emitting diode includes three cells.

The light emitting diode may be one of a red light emitting diode, a green light emitting diode, and a blue light emitting diode.

The red light emitting diode may include three cells disposed between the first pad and the second pad.

The green light emitting may include includes two cells disposed between the first pad and the second pad.

The blue light emitting diode may include two cells disposed between the first pad and the second pad.

The red light emitting diode may include five cells.

Each of the green light emitting diode and the blue light emitting diode may include four cells.

The display apparatus may further include a plurality of light emitting diode groups arranged in a plurality of rows and a plurality of columns on the substrate, each of the plurality of light emitting diode groups including the red light emitting diode, the green light emitting diode, and the blue light emitting diode.

The display apparatus may further include a dimming block including light emitting diode groups among the plurality of light emitting diode groups that are connected to be turned on or off simultaneously.

In each of the light emitting diode groups of the dimming block, a magnitude of a voltage applied to the red light emitting diode, a magnitude of a voltage applied to the green light emitting diode, and a magnitude of a voltage applied to the blue light emitting diode may be provided to be the same.

The display apparatus may further include a reflective sheet having a plurality of holes, each of the plurality of light emitting diode groups being disposed in a corresponding one of the holes, the reflective sheet being provided to cover the one surface of the substrate.

The display apparatus may further include a plurality of optical domes respectively provided inside the plurality of holes and configured to cover the respective plurality of light emitting diode groups.

According to an aspect of the present disclosure, a display apparatus that improves the lifespan and color stability of light emitting diodes by driving the light emitting diodes with high voltage and low current can be provided.

According to an aspect of the present disclosure, a display apparatus capable of reducing voltage loss while supplying a common voltage to red, green, and blue light emitting diodes can be provided.

According to an aspect of the present disclosure, a display apparatus in which a red light emitting diode, a green light emitting diode, and a blue light emitting diode form one light emitting diode group, and the red light emitting diode includes more cells than the green light emitting diode and the blue light emitting diode can be provided.

According to an aspect of the present disclosure, a display apparatus including a light emitting diode in which at least one cell is disposed between an anode pad and a cathode pad can be provided.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

What is claimed is:

1. A display apparatus comprising:
a liquid crystal panel; and
a backlight unit configured to provide light to the liquid crystal panel,
wherein the backlight unit comprises:
a substrate;
a red light emitting diode mounted on a first surface of the substrate;
a green light emitting diode mounted on the first surface of the substrate; and
a blue light emitting diode mounted on the first surface of the substrate,
wherein the red light emitting diode comprises a first plurality of cells,
wherein the green light emitting diode comprises a second plurality of cells, and
wherein the blue light emitting diode comprises a third plurality of cells.

2. The display apparatus of claim 1, wherein the first plurality of cells of the red light emitting diode comprises four cells,
wherein the second plurality of cells of the green light emitting diode comprises three cells, and
wherein the third plurality of cells of the blue light emitting diode comprises three cells.

3. The display apparatus of claim 1, wherein the first plurality of cells of the red light emitting diode comprises five cells,
wherein the second plurality of cells of the green light emitting diode comprises four cells, and
wherein the third plurality of cells of the blue light emitting diode comprises four cells.

4. The display apparatus of claim 1, further comprising:
a plurality of red light emitting diodes, the plurality of red light emitting diodes comprising the red light emitting diode;
a plurality of green light emitting diodes, the plurality of green light emitting diodes comprising the green light emitting diode;
a plurality of blue light emitting diodes, the plurality of blue light emitting diodes comprising the blue light emitting diode;
a plurality of light emitting diode groups arranged in a plurality of rows and a plurality of columns on the substrate, a first light emitting diode group of the plurality of light emitting diode groups comprising a first red light emitting diode of the plurality of red light emitting diodes, a first green light emitting diode of the plurality of green light emitting diodes, and a first blue light emitting diode of the plurality of blue light emitting diodes, and a second light emitting diode group of the plurality of light emitting diode groups comprising a second red light emitting diode of the plurality of red light emitting diodes, a second green light emitting diode of the plurality of green light emitting diodes, and a second blue light emitting diode of the plurality of blue light emitting diodes; and
a dimming block comprising ones of the plurality of light emitting diode groups that are configured to be any of turned on and off simultaneously.

5. The display apparatus of claim 4, wherein the ones of the plurality of light emitting diode groups of the dimming block comprise the first light emitting diode group and the second light emitting diode group,
a magnitude of a voltage applied to the first red light emitting diode, a magnitude of a voltage applied to the first green light emitting diode, and a magnitude of a voltage applied to the first blue light emitting diode are provided to be the same, and
a magnitude of a voltage applied to the second red light emitting diode, a magnitude of a voltage applied to the second green light emitting diode, and a magnitude of a voltage applied to the second blue light emitting diode are provided to be the same.

6. The display apparatus of claim 4, further comprising:
a reflective sheet comprising a plurality of holes, each of which accommodates a respective one of the plurality of light emitting diode groups, configured to cover the first surface of the substrate; and
a plurality of optical domes, each provided inside a respective one of the plurality of holes, configured to cover a corresponding one of the plurality of light emitting diode groups.

7. The display apparatus of claim 1, further comprising:
a first power feeding pad, that is a part of a conductive layer that is at least a portion of the first surface of the substrate, configured to apply a positive voltage to the red light emitting diode, the green light emitting diode, and the blue light emitting diode; and
a second power feeding pad, that is a part of the conductive layer, configured to apply a negative voltage to the red light emitting diode, the green light emitting diode, and the blue light emitting diode.

8. The display apparatus of claim 7, wherein the red light emitting diode comprises a first pad, configured to be electrically connected to the first power feeding pad, and a second pad configured to be electrically connected to the second power feeding pad;
the green light emitting diode comprises a third pad, configured to be electrically connected to the first power feeding pad, and a fourth pad configured to be electrically connected to the second power feeding pad; and
the blue light emitting diode comprises a fifth pad, configured to be electrically connected to the first power feeding pad, and a sixth pad configured to be electrically connected to the second power feeding pad.

9. The display apparatus of claim 8, wherein the first plurality of cells of the red light emitting diode comprises two cells disposed between the first pad and the second pad;
the second plurality of cells of the green light emitting diode comprises one cell disposed between the third pad and the fourth pad; and
the third plurality of cells of the blue light emitting diode comprises one cell disposed between the fifth pad and the sixth pad.

10. The display apparatus of claim 8, wherein the first plurality of cells of the red light emitting diode comprises three cells disposed between the first pad and the second pad;
the second plurality of cells of the green light emitting diode comprises two cells disposed between the third pad and the fourth pad; and
the third plurality of cells of the blue light emitting diode comprises two cells disposed between the fifth pad and the sixth pad.

11. The display apparatus of claim 9, wherein a length of a short side of each of the two cells disposed between the first pad and the second pad of the red light emitting diode is 100 μm or less;
a length of a short side of the one cell disposed between the third pad and the fourth pad of the green light emitting diode is 100 μm or less; and
a length of a short side of the one cell disposed between the fifth pad and the sixth pad of the blue light emitting diode is 100 μm or less.

12. A display apparatus comprising:
a liquid crystal panel; and
a backlight unit configured to provide light to the liquid crystal panel,
wherein the backlight unit comprises:
a substrate comprising an insulating layer and a conductive layer;
a light emitting diode mounted on the substrate and comprising a first pad, that is an anode, and a second pad that is a cathode;
a first power feeding pad of the conductive layer and configured to connect a positive electrode to the first pad; and
a second power feeding pad of the conductive layer configured to connect a negative electrode to the second pad,
wherein the light emitting diode comprises at least one cell disposed between the first pad and the second pad.

13. The display apparatus of claim 12, wherein the light emitting diode is one of a red light emitting diode, a green light emitting diode, and a blue light emitting diode,
the red light emitting diode comprises two cells disposed between the first pad and the second pad,
the green light emitting diode comprises one cell disposed between the first pad and the second pad, and
the blue light emitting diode comprises one cell disposed between the first pad and the second pad.

14. The display apparatus of claim 13, wherein
the red light emitting diode comprises four cells,
the green light emitting diode comprises three cells, and
the blue light emitting diode comprises three cells.

15. The display apparatus of claim 12, wherein the light emitting diode is one of a red light emitting diode, a green light emitting diode, and a blue light emitting diode,
the red light emitting diode comprises three cells disposed between the first pad and the second pad,
the green light emitting diode comprises two cells disposed between the first pad and the second pad, and
the blue light emitting diode comprises two cells disposed between the first pad and the second pad.
